(19) United States
(12) Patent Application Publication
(10) Pub. No.: US 2016/0312871 A1
(43) Pub. Date: Oct. 27, 2016

(54) Original Shift System (O.S.S.)

(71) Applicants: Huan Hsiung Tseng, Walnut, CA (US); Kuo-Hung Tseng, Walnut, CA (US)

(72) Inventors: Huan Hsiung Tseng, Walnut, CA (US); Kuo-Hung Tseng, Walnut, CA (US)

(21) Appl. No.: 14/859,302

(22) Filed: Sep. 20, 2015

Related U.S. Application Data
(60) Provisional application No. 62/152,175, filed on Apr. 24, 2015.

(51) Int. Cl. F16H 37/16

(52) U.S. Cl. CPC F16H 37/16

(57) ABSTRACT

Original Shift System (O.S.S.) is a transmission system that has infinite variations in gear ratios and is suitable for small to heavy duty torque applications. It is comprised of two main systems:

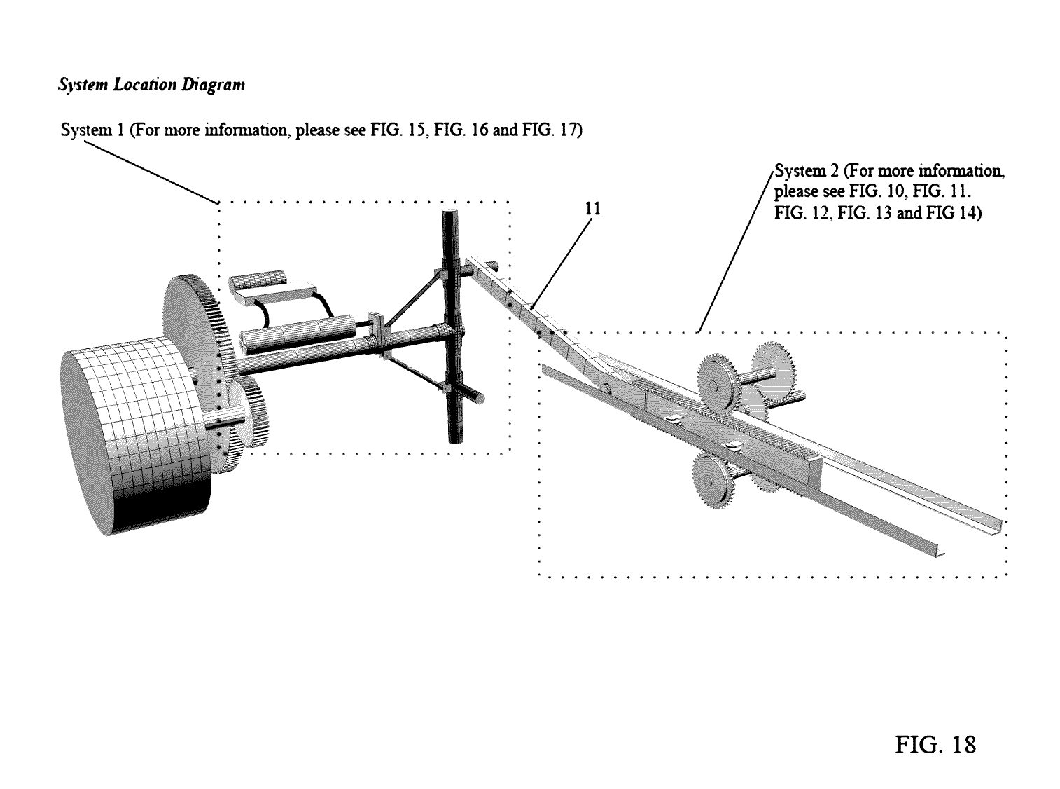

1.) Speed Shift System (Please see System 1 on FIG. 18)
a. Composed of a system of hydraulically controlled sliding sleeves and stretchers mounted on a rotating shaft with an arm.
b. These sliding sleeves and stretchers work similar to how an umbrella opens and closes.

2.) Energy Collection System (Please see System 2 on FIG. 18)
a. Composed of 2 Freewheel gears, 3 regular gears, 1 double sided rack sliding on rails and an output shaft.

The power is transferred into System 1 via a motor; to System 2 via a connecting rod (11 in FIG. 18); and out of System 2 via an output shaft.

1

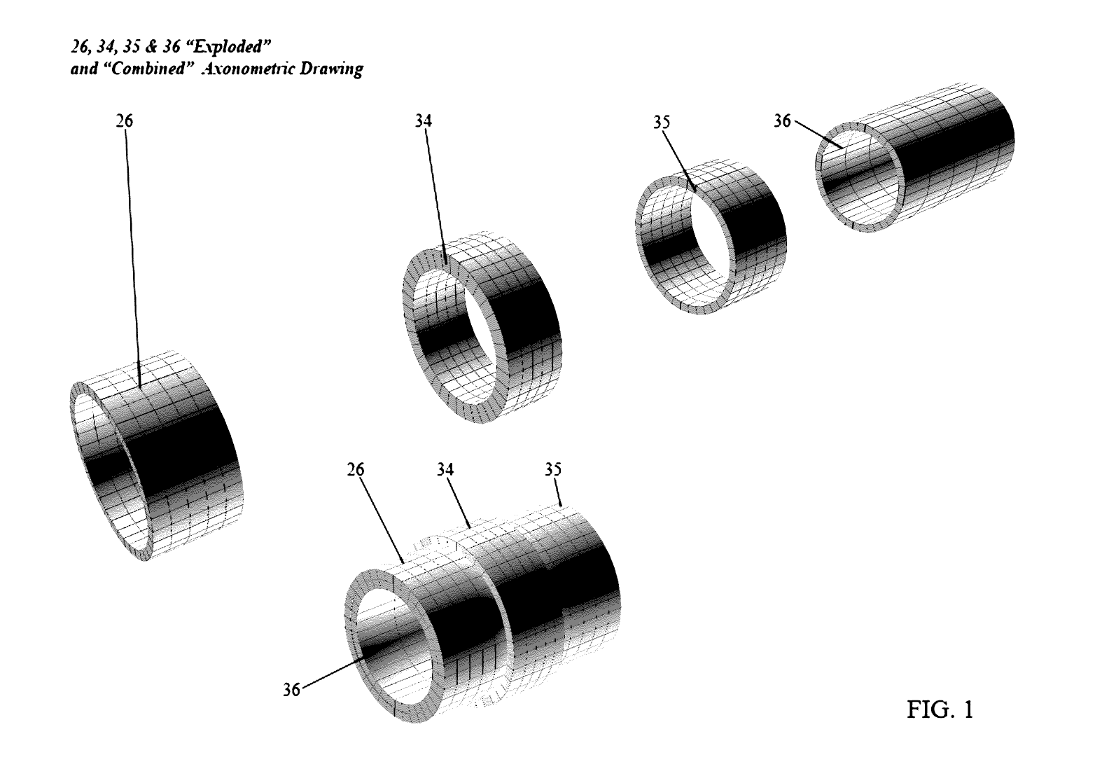

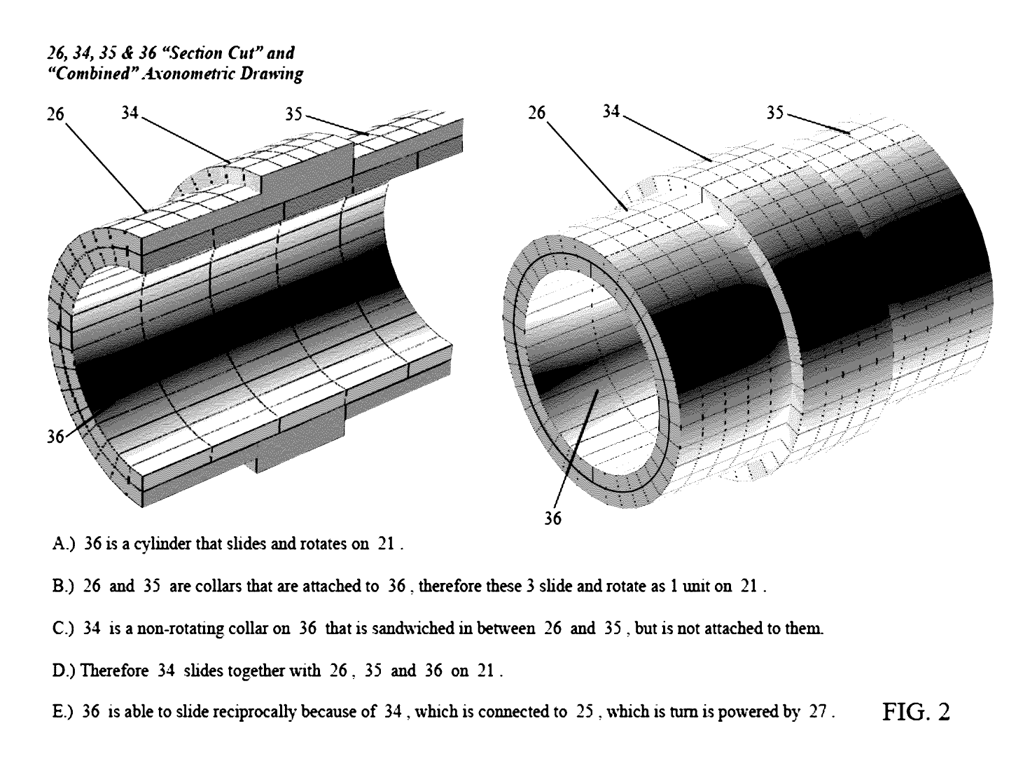

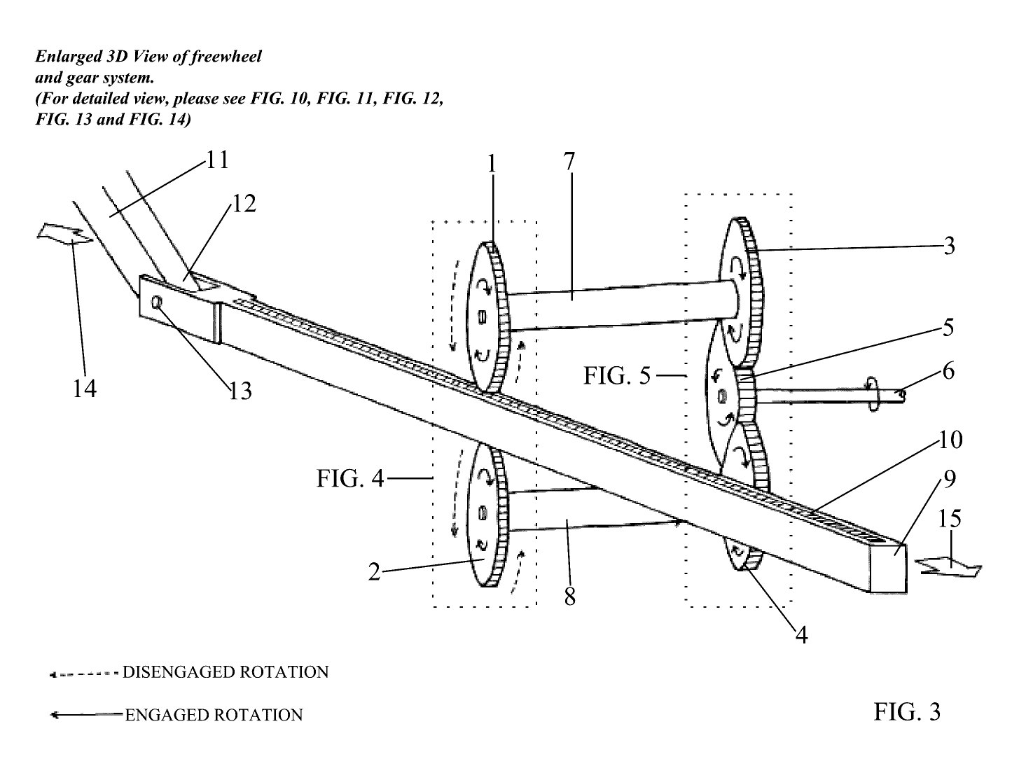

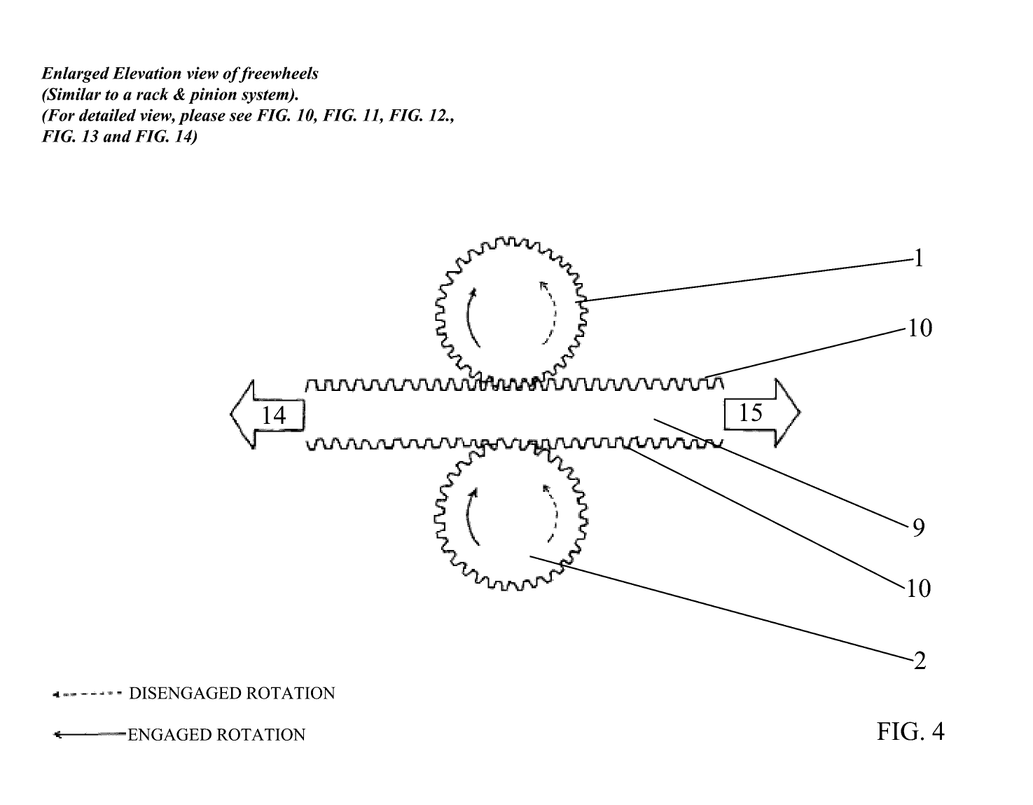

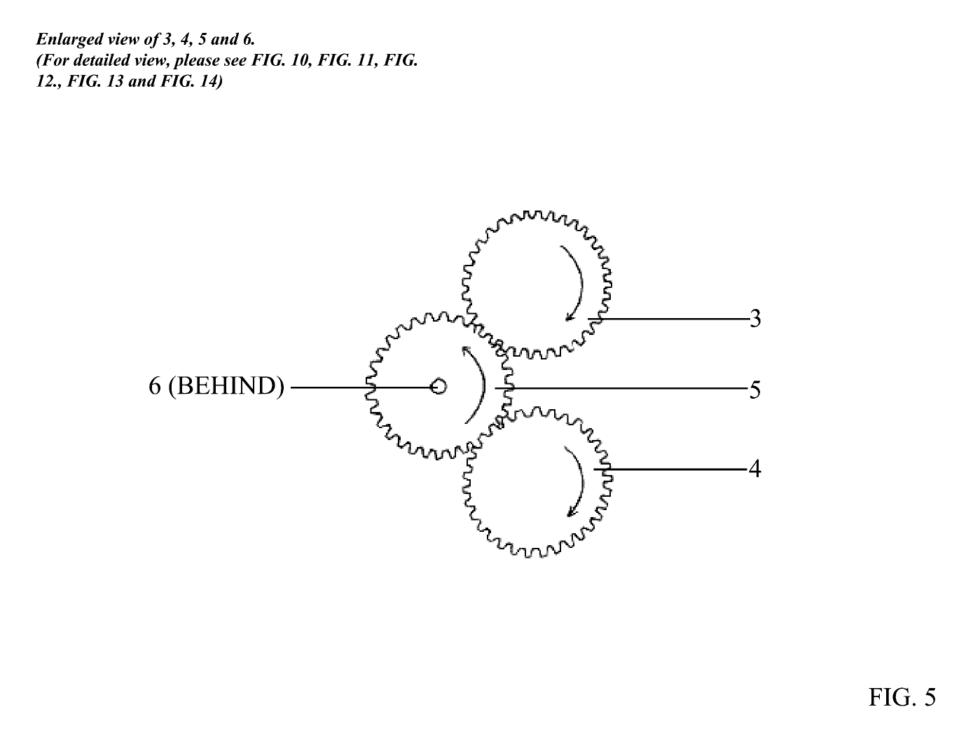

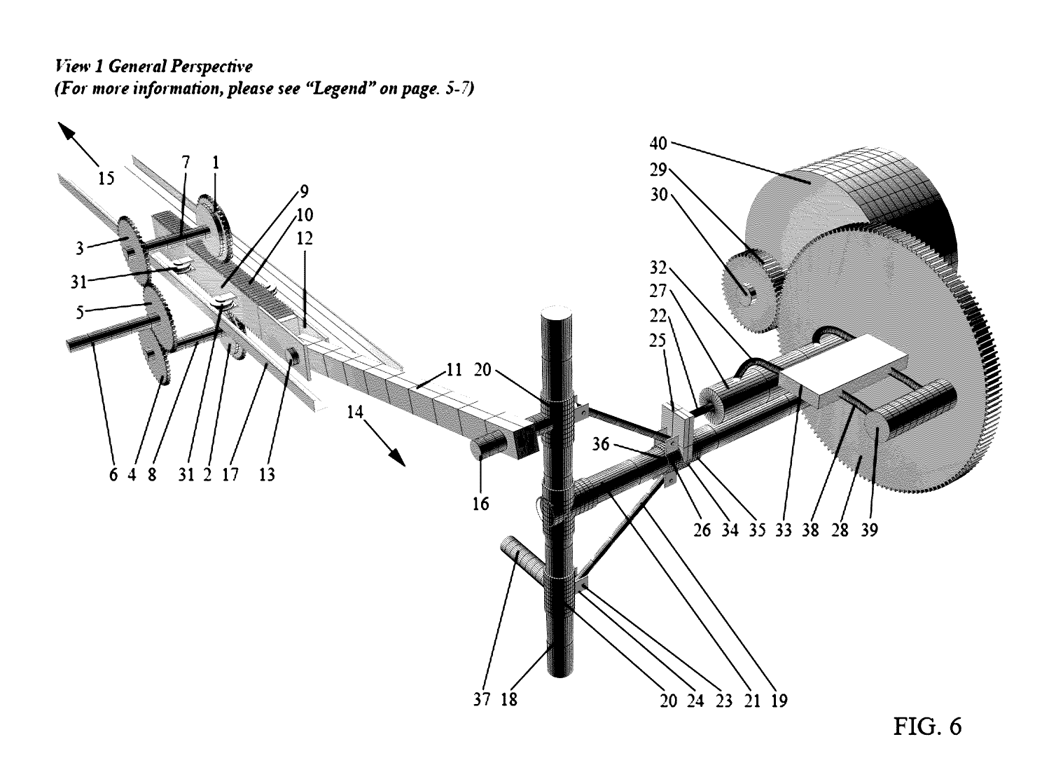

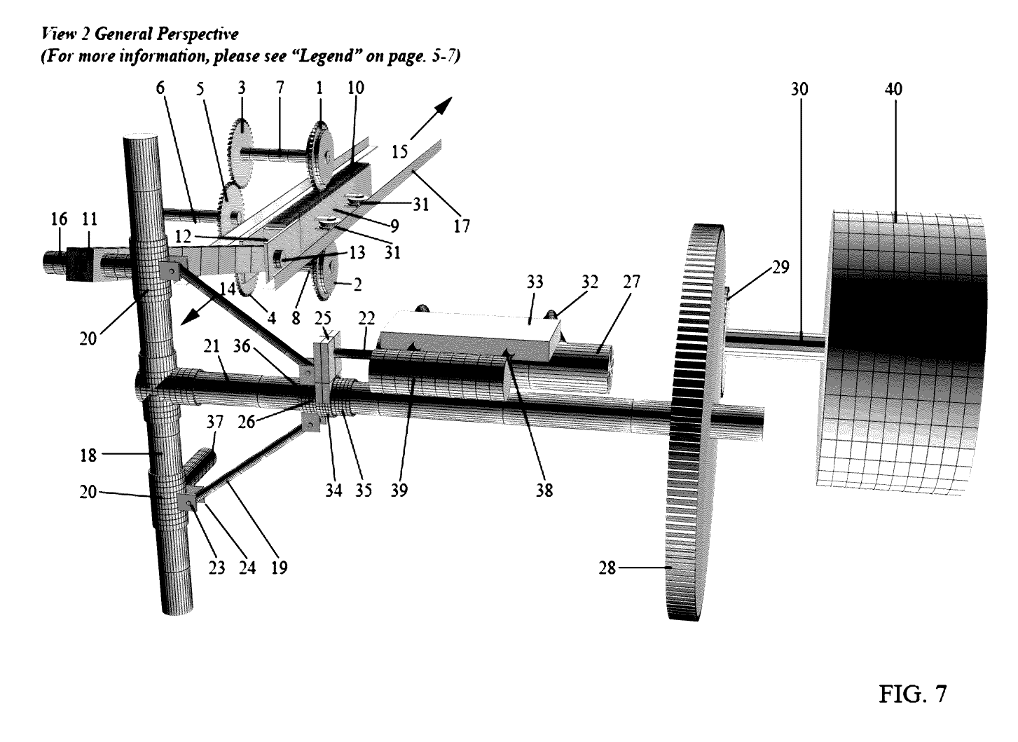

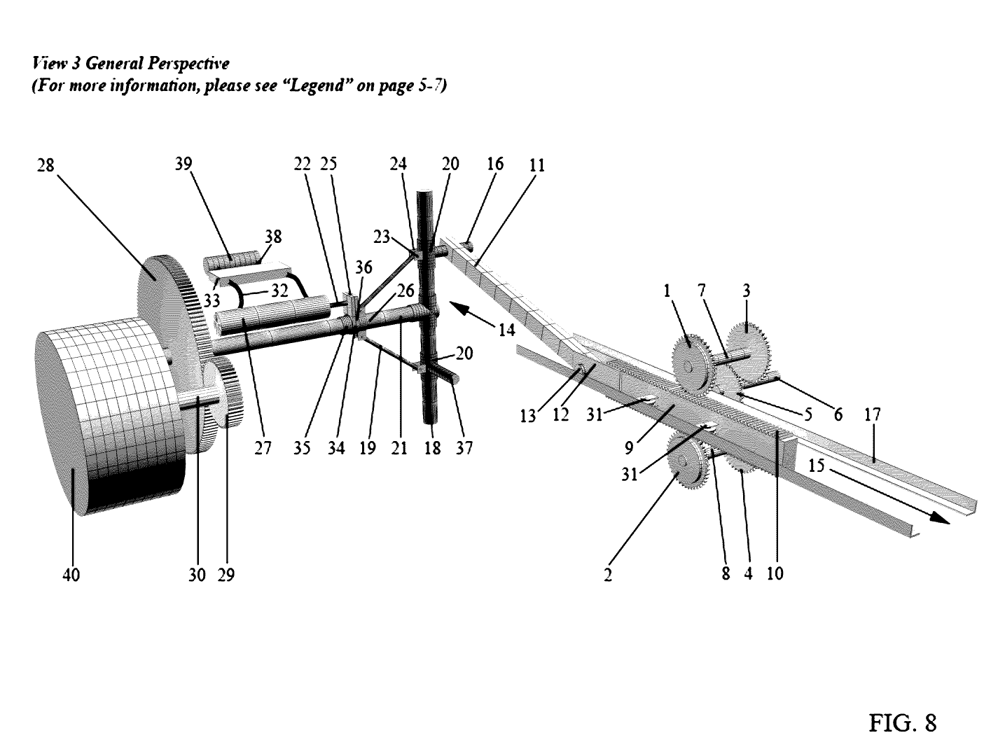

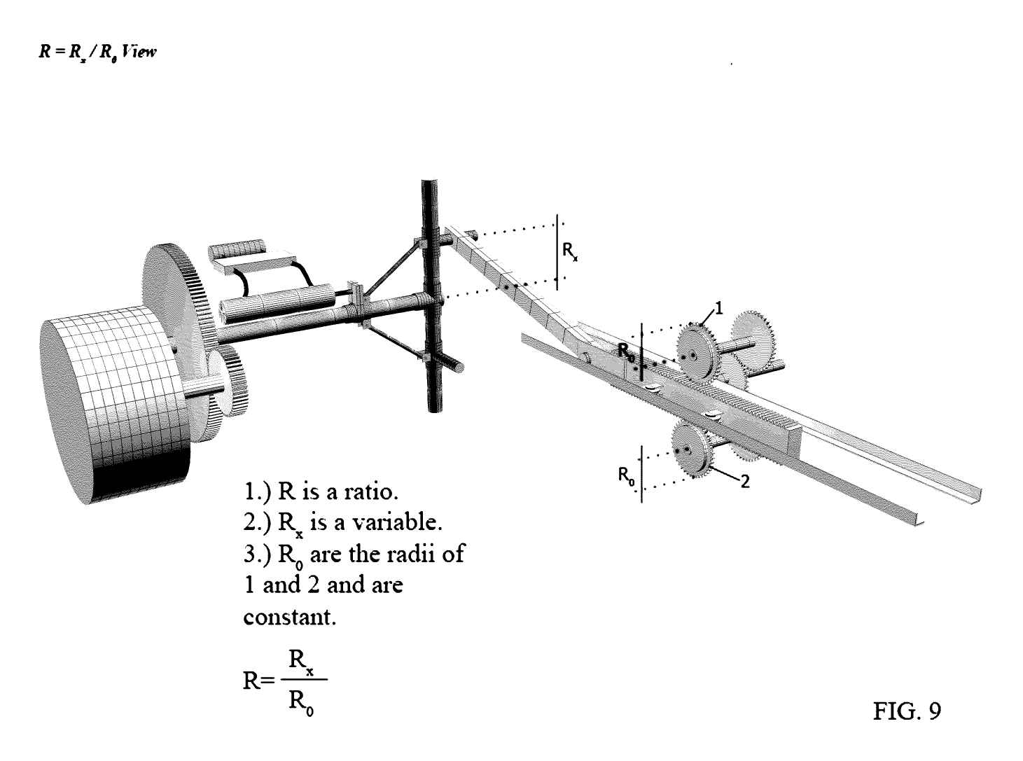

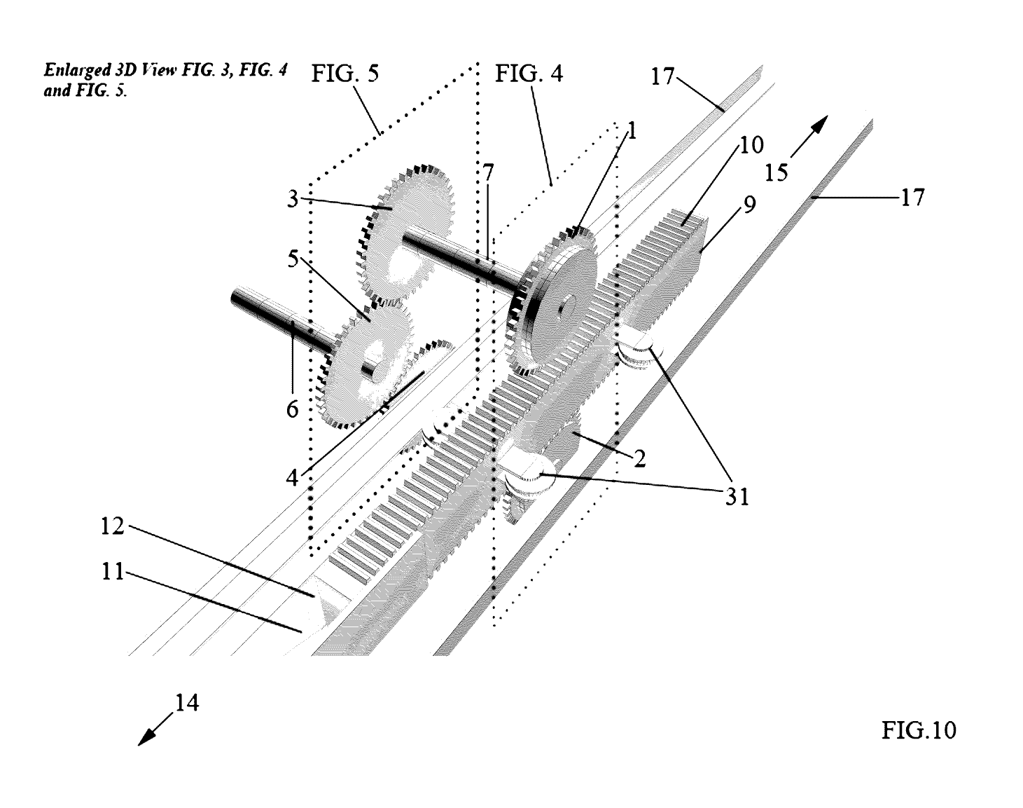

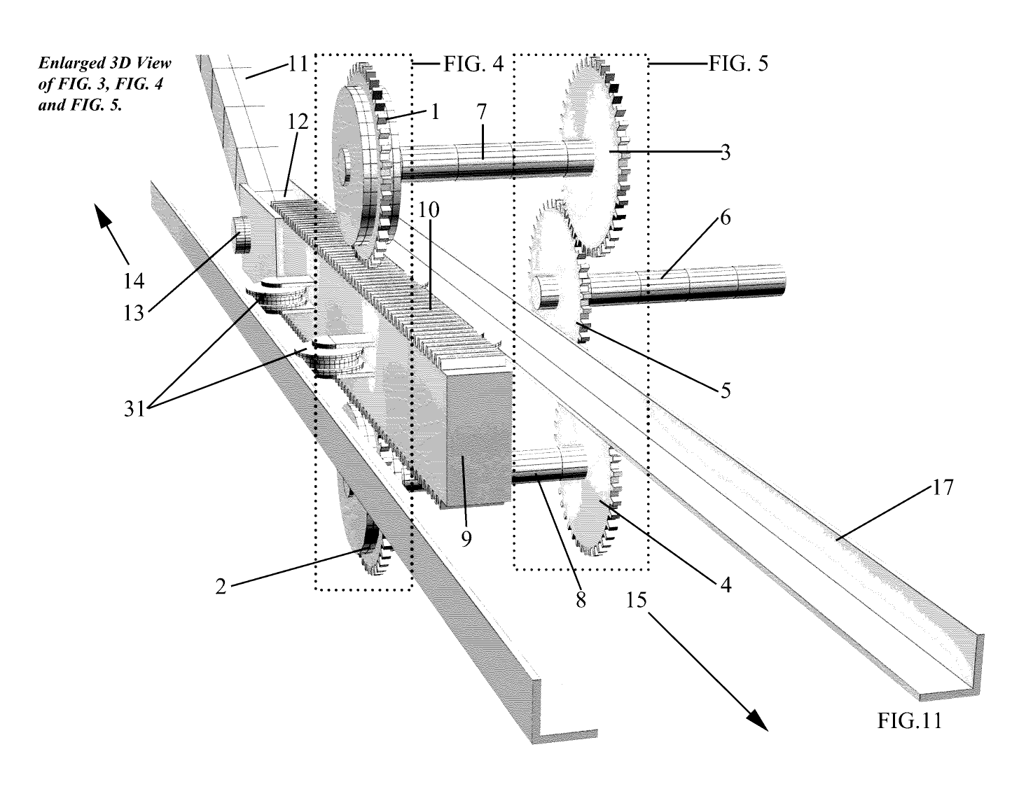

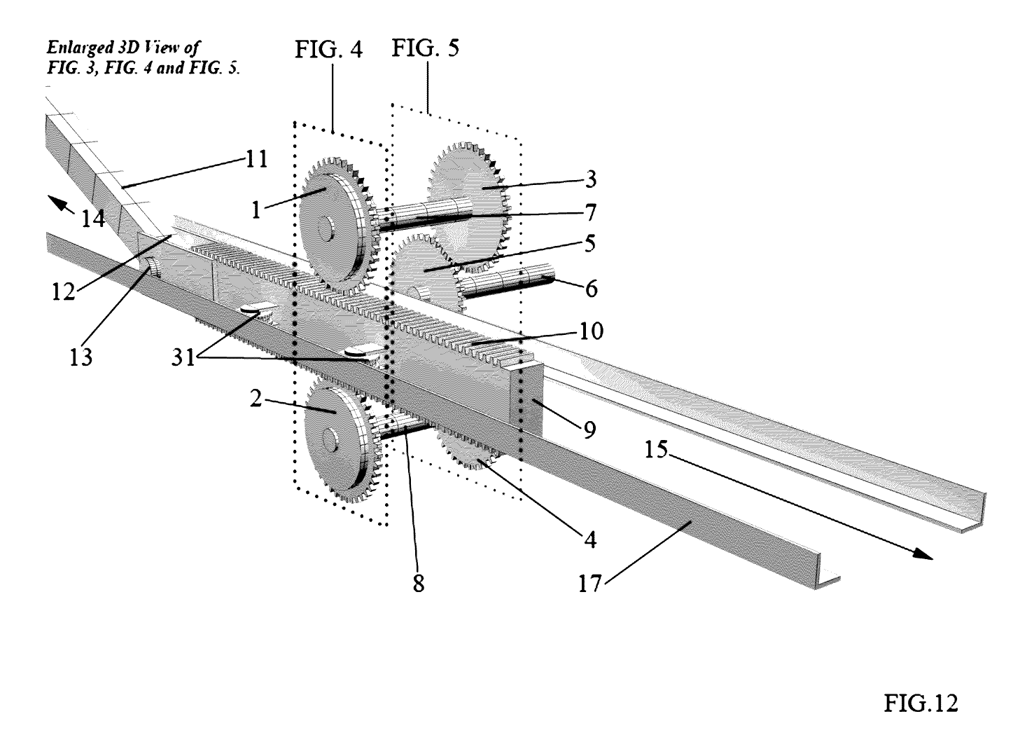

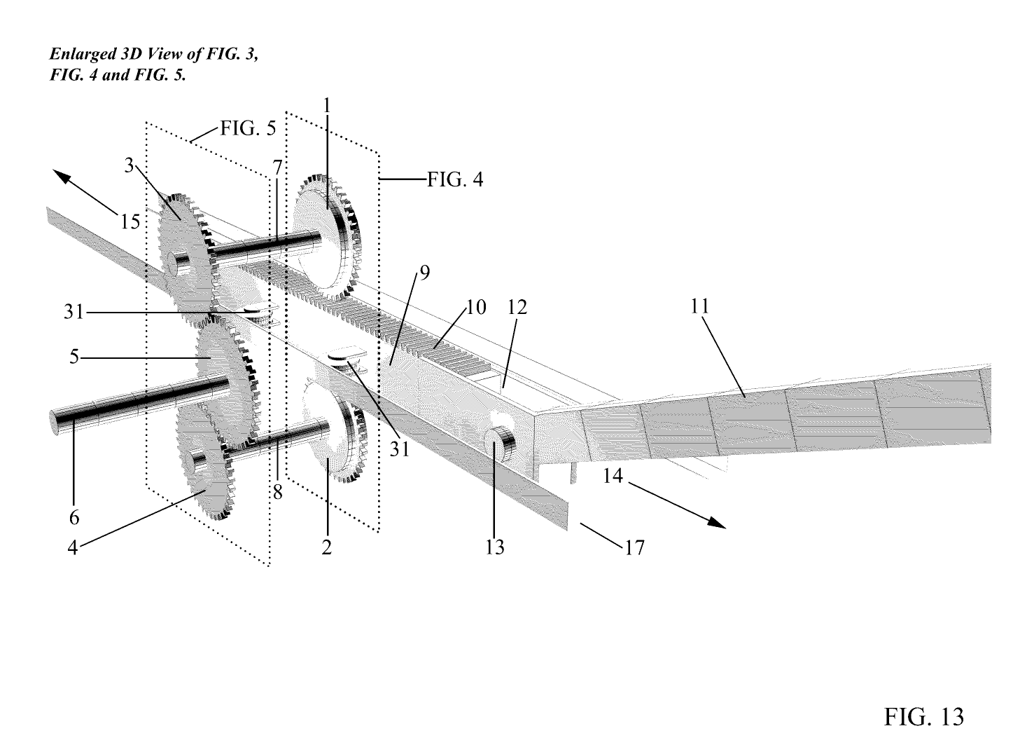

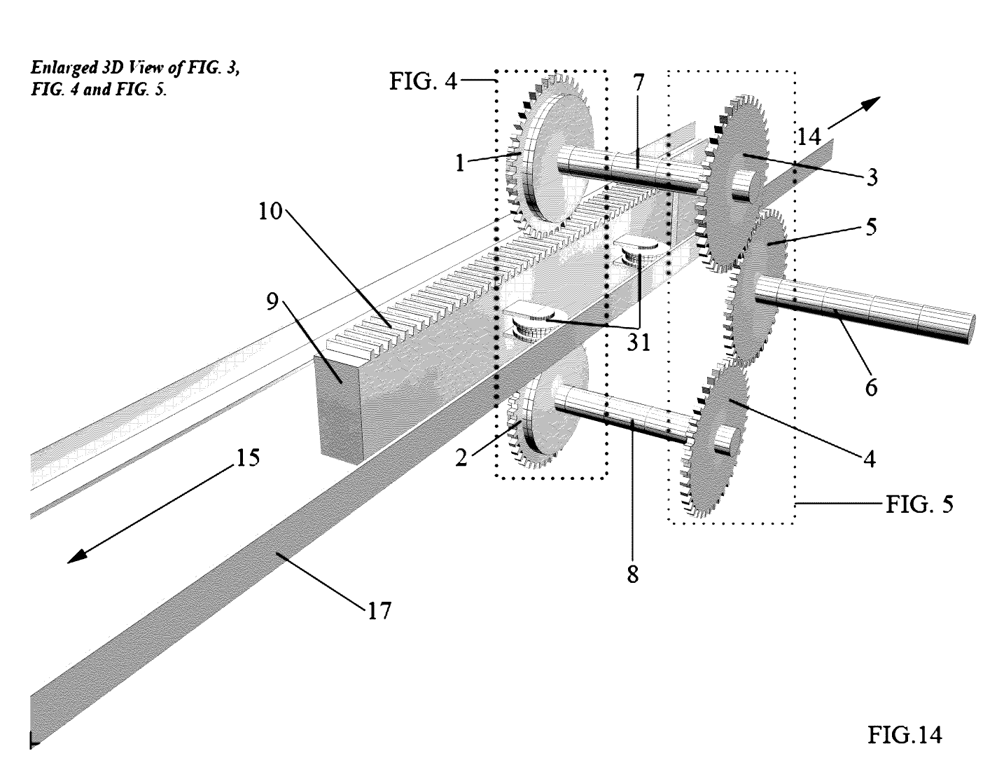

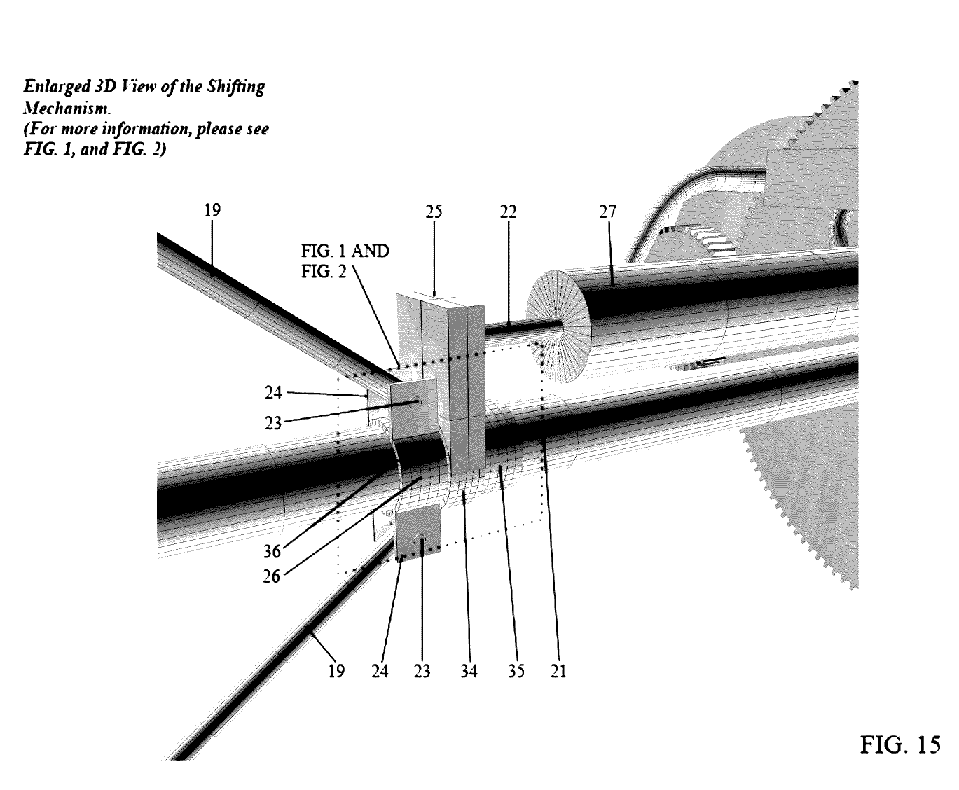

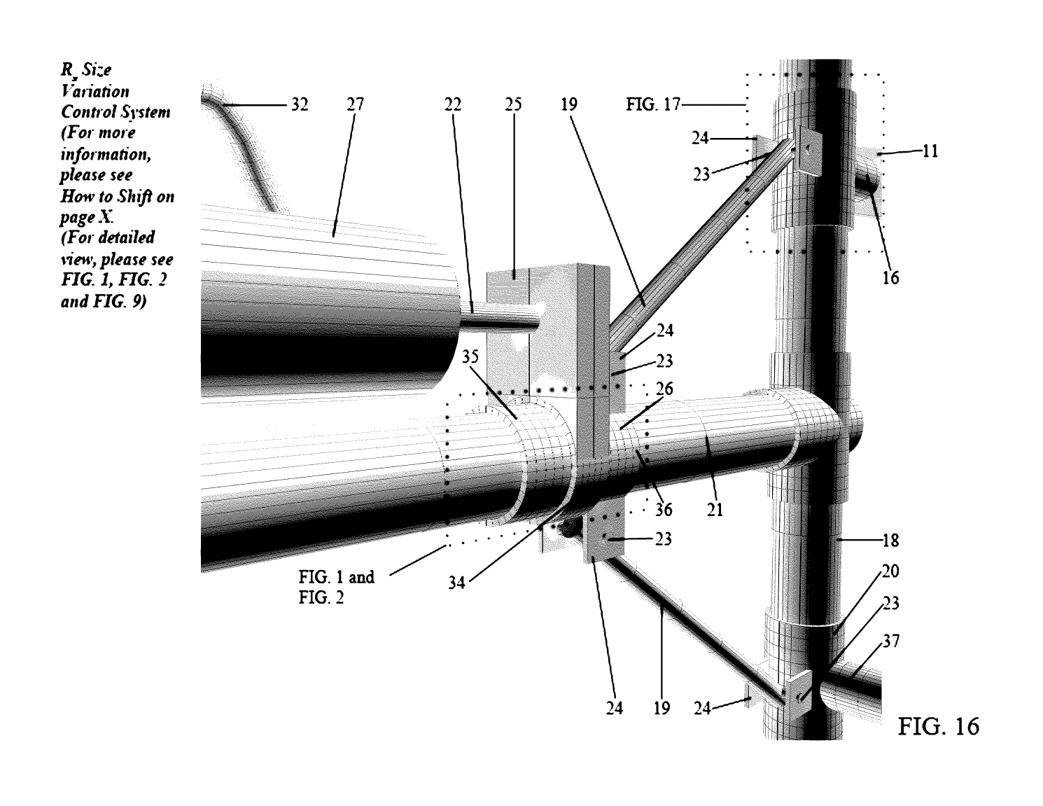

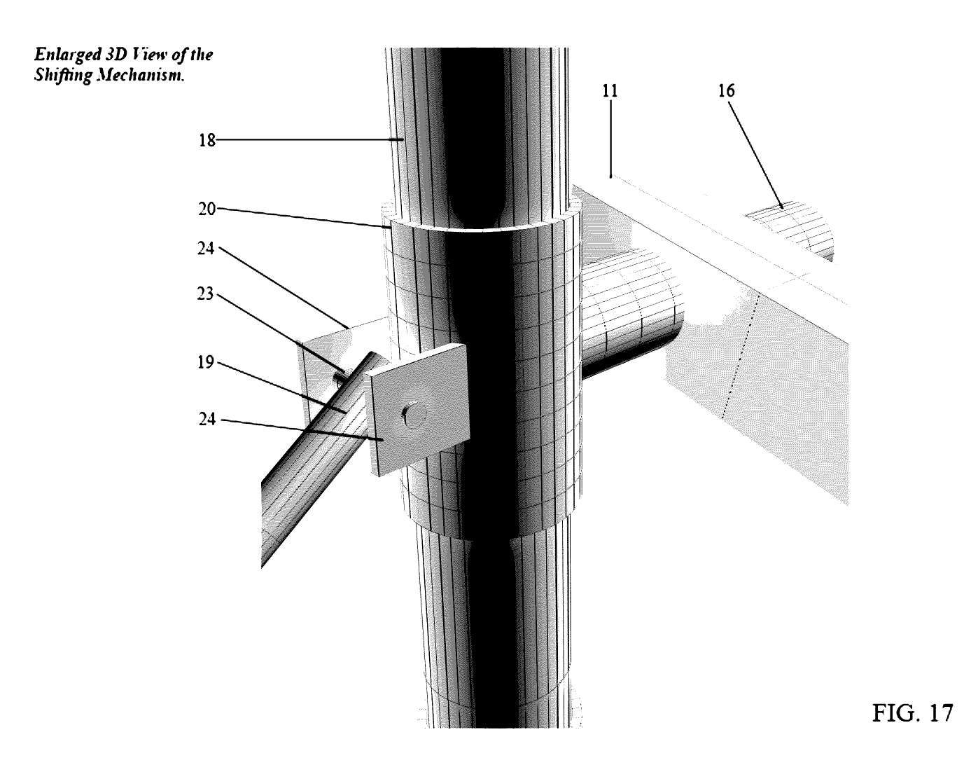

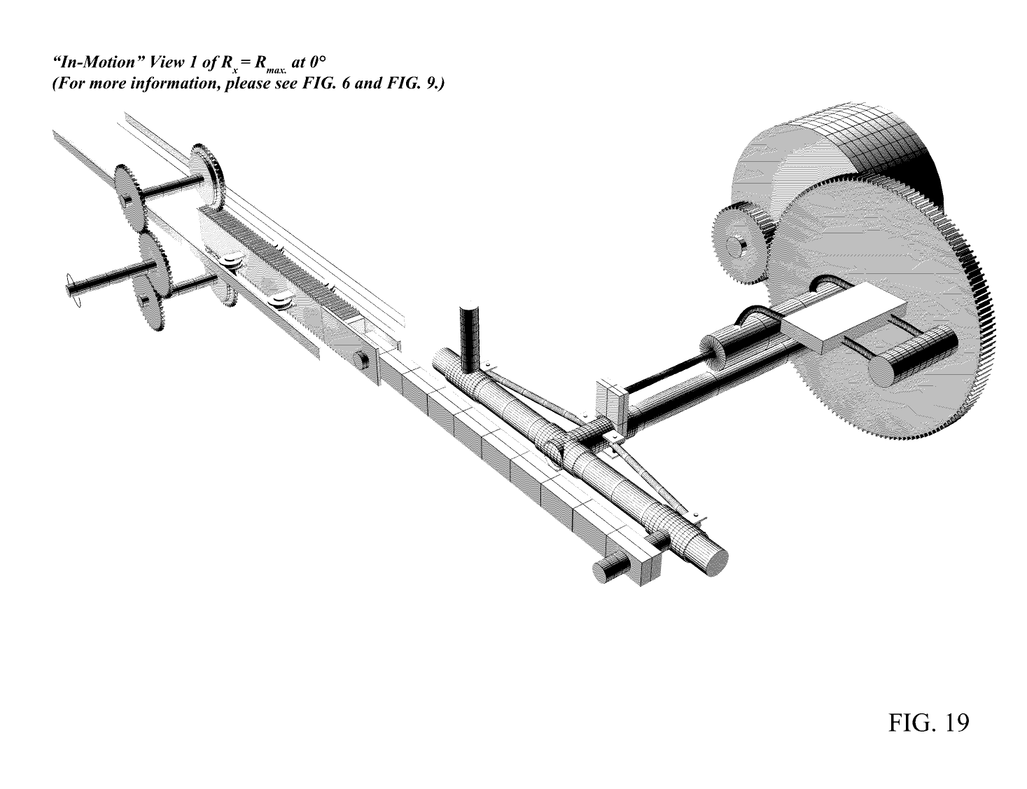

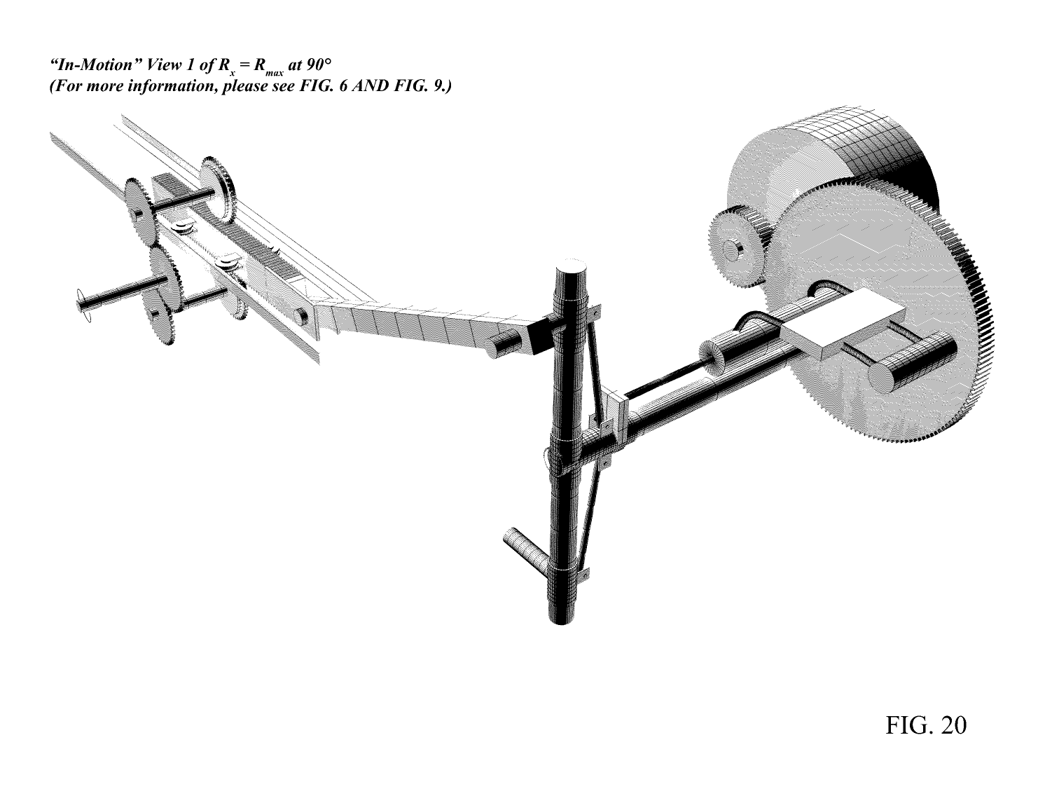

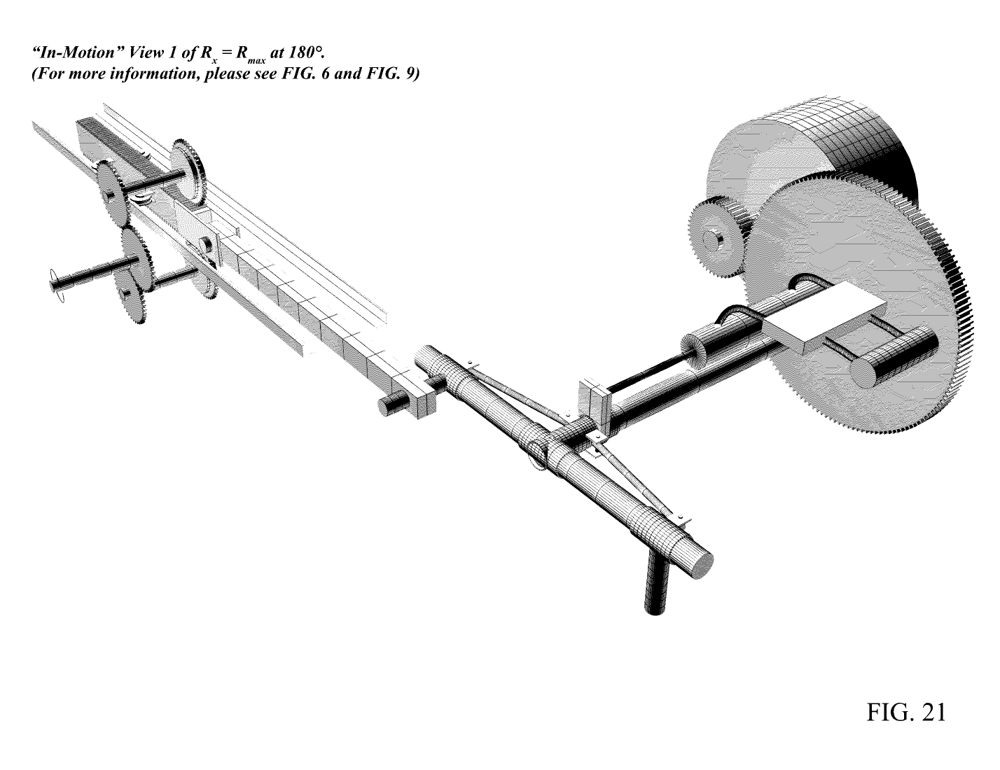

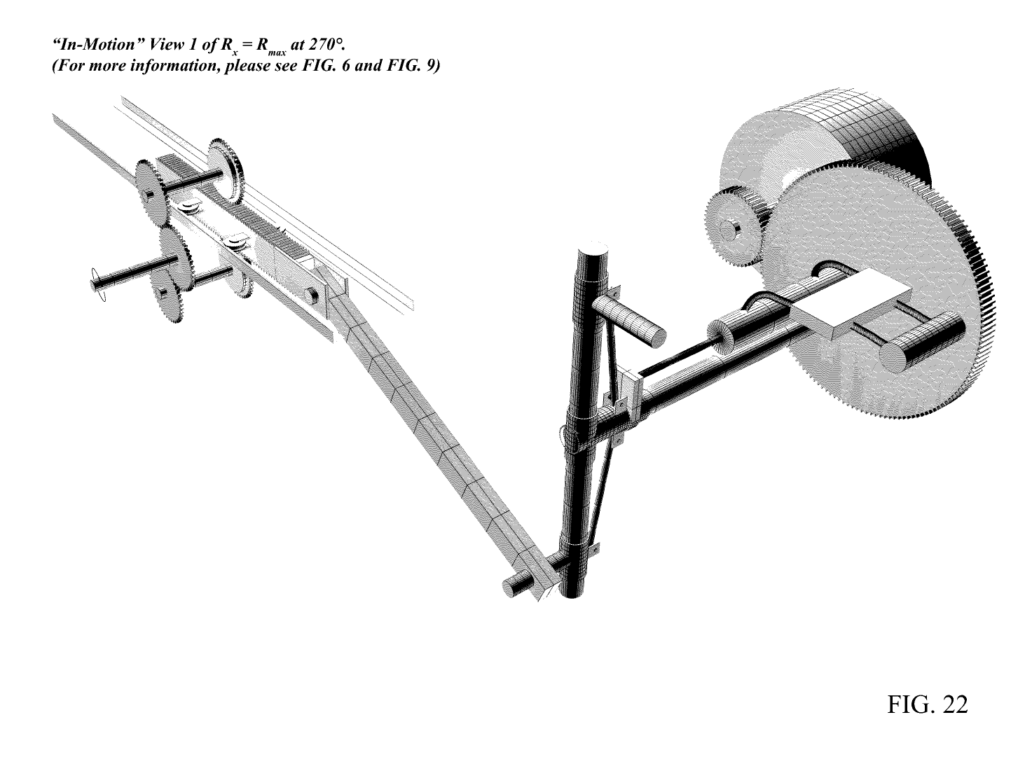

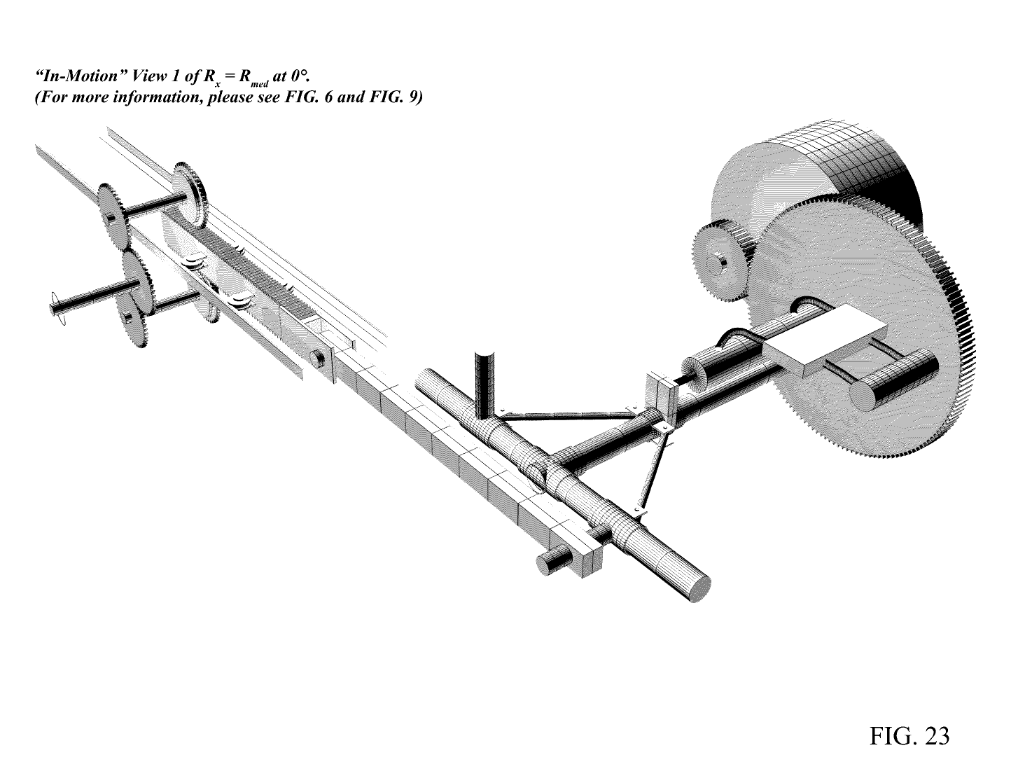

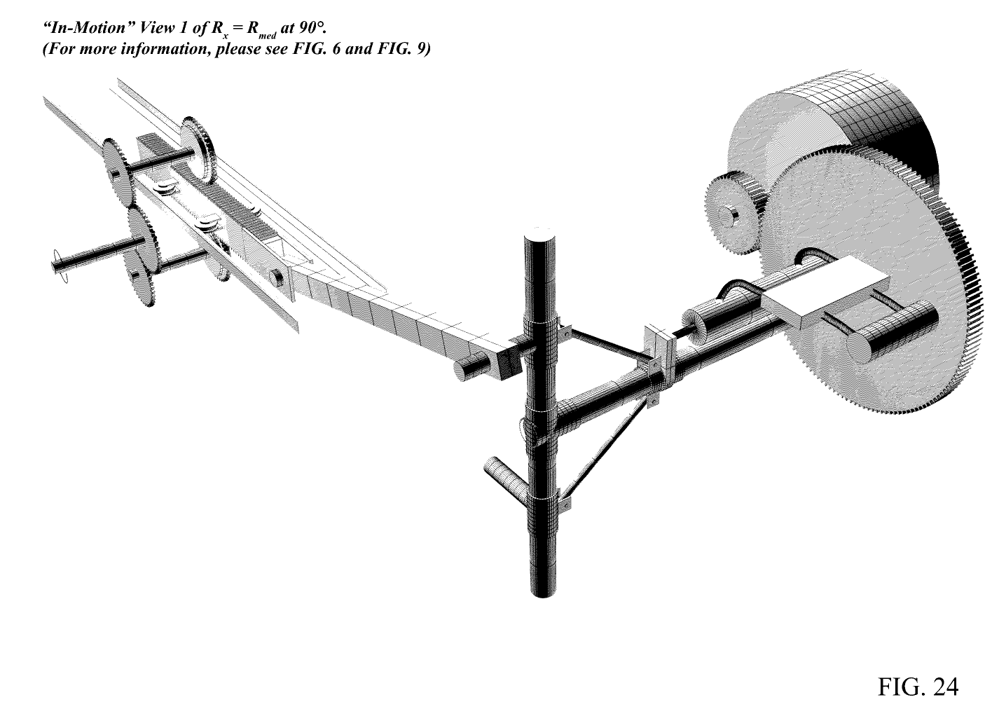

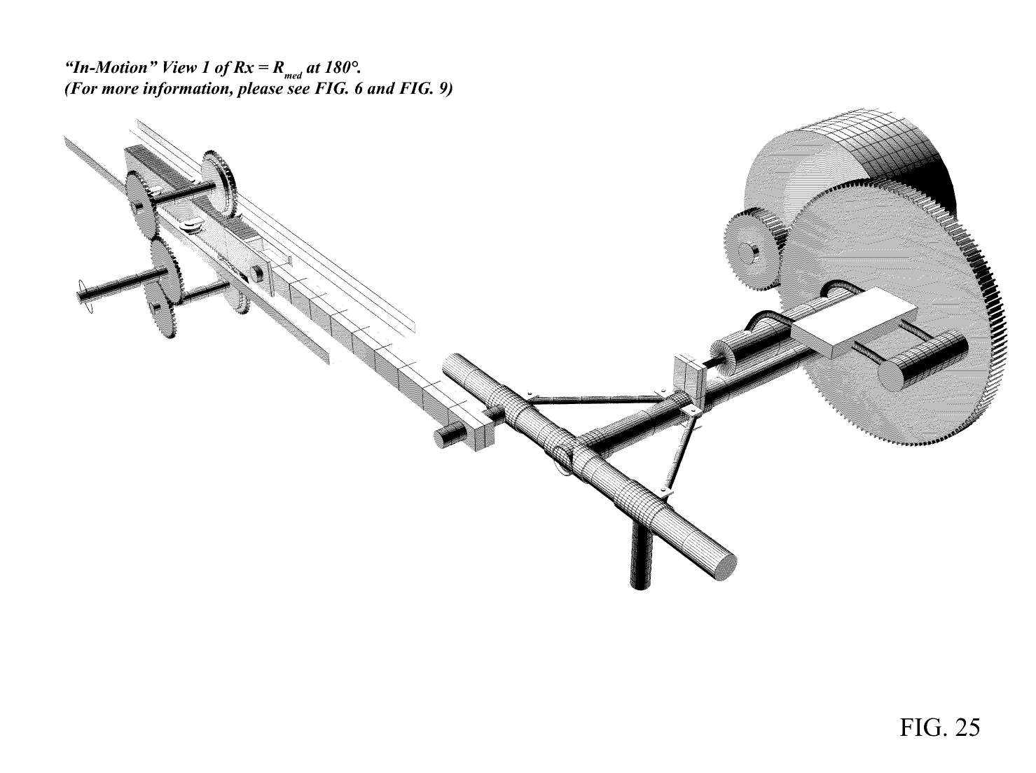

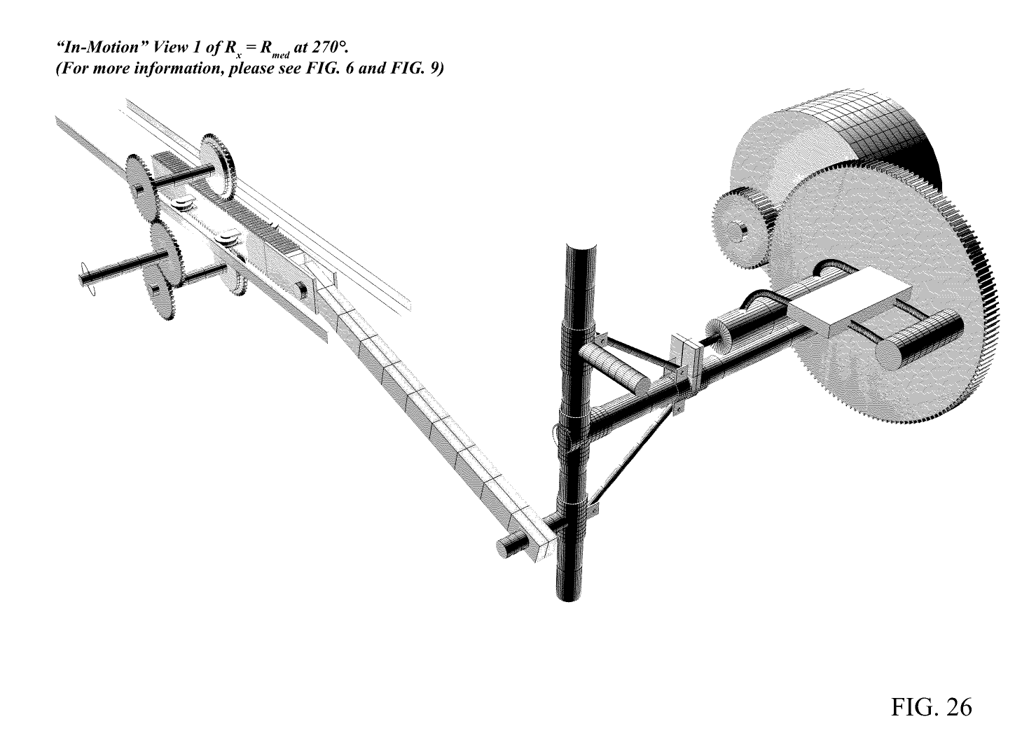

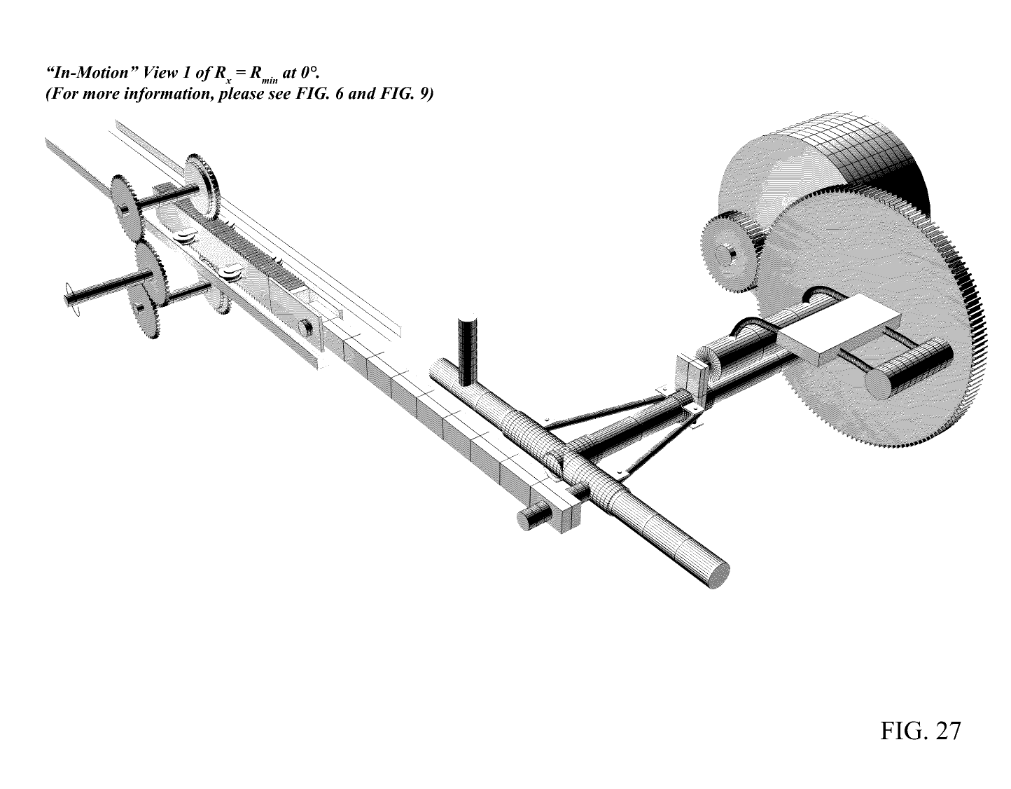

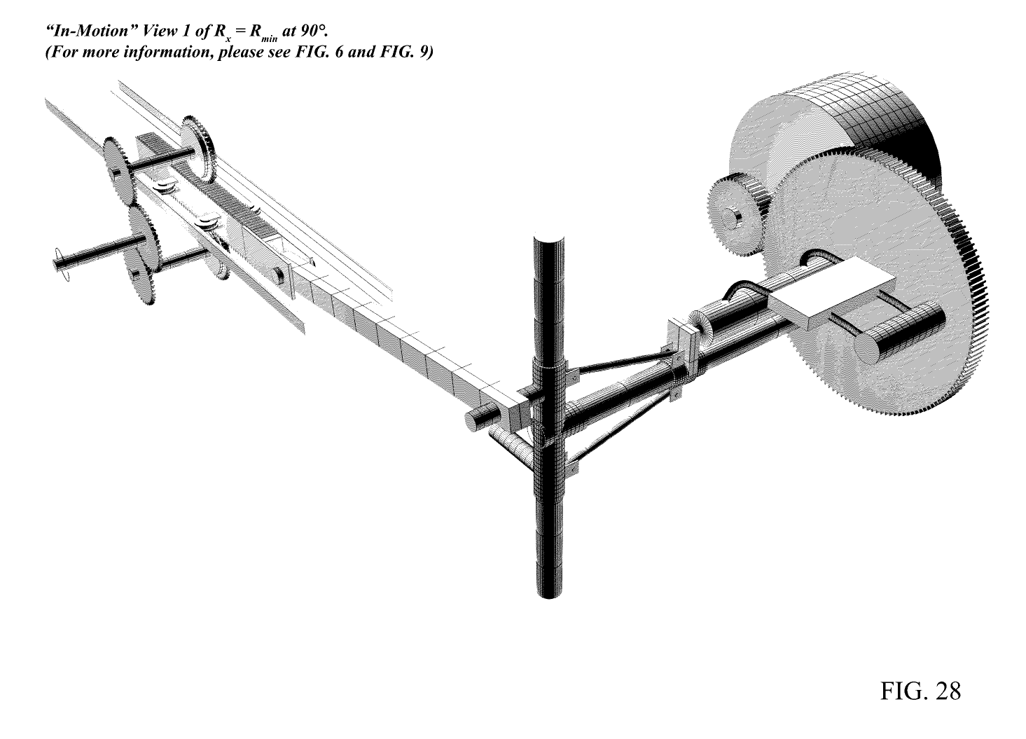

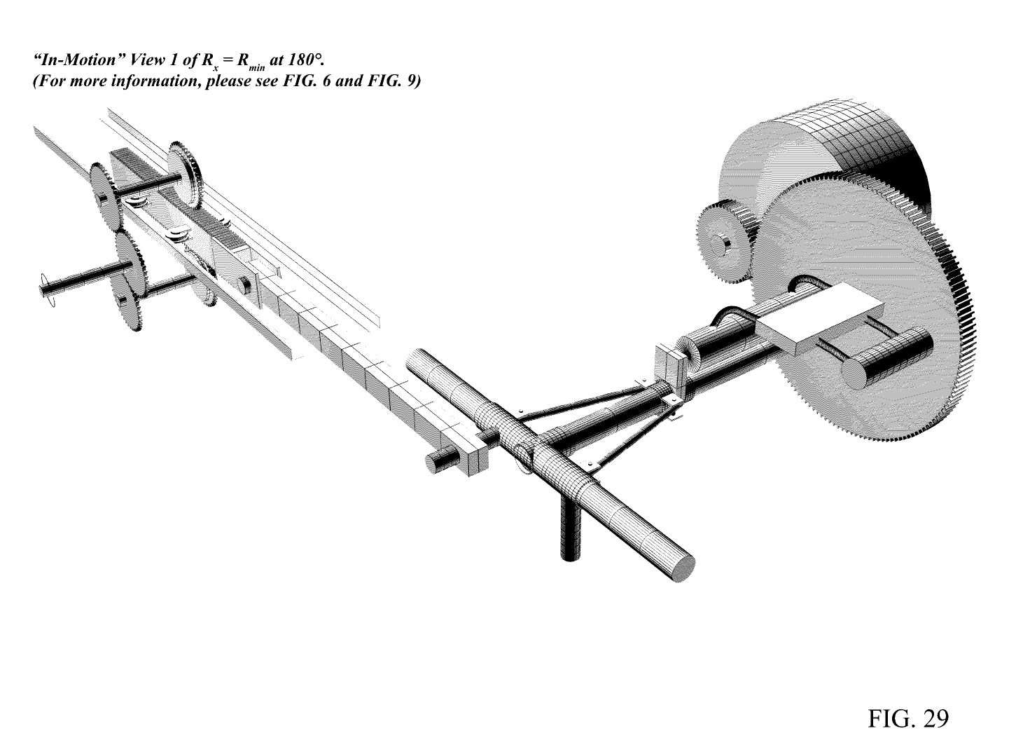

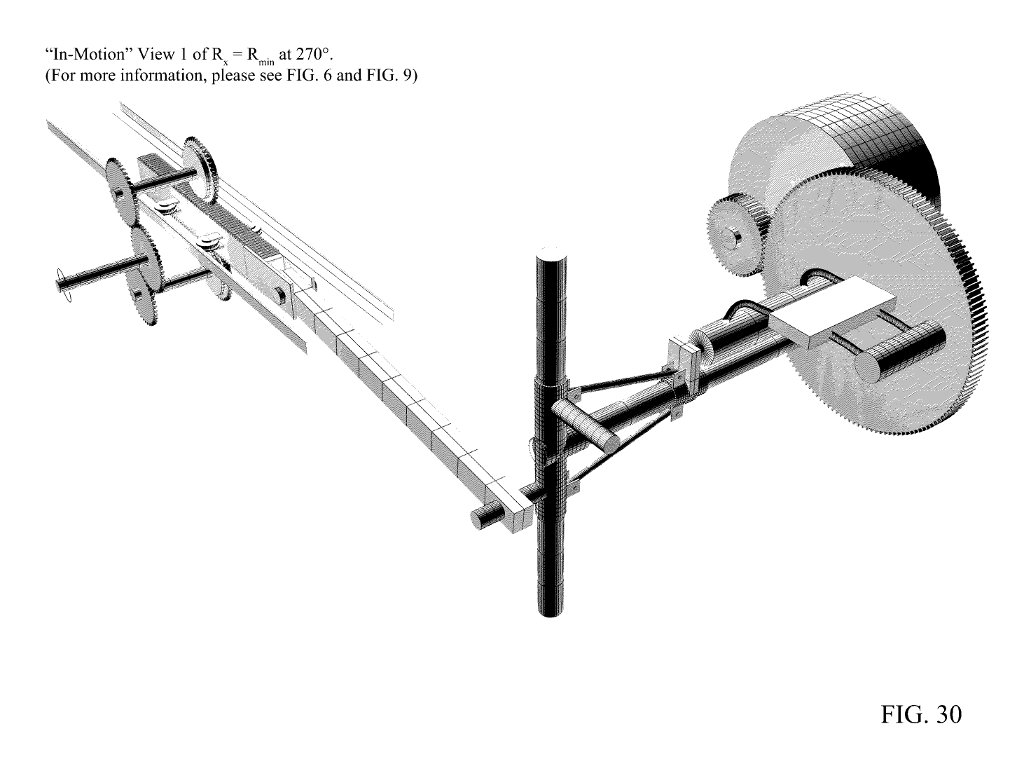

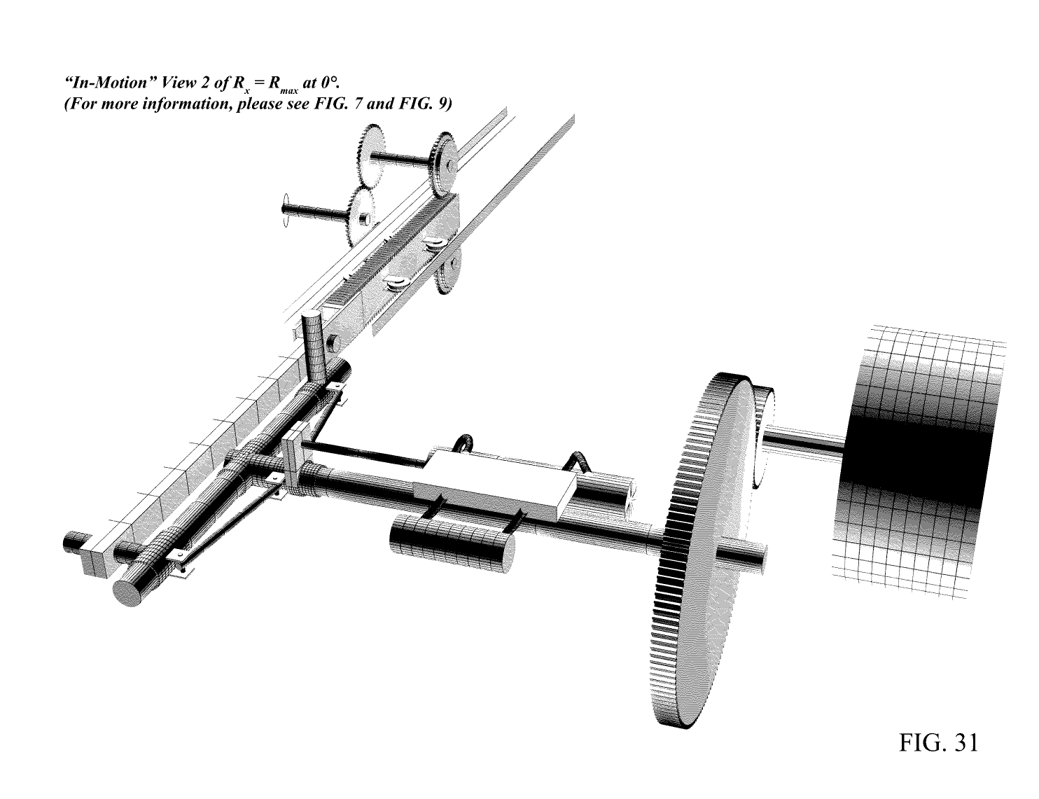

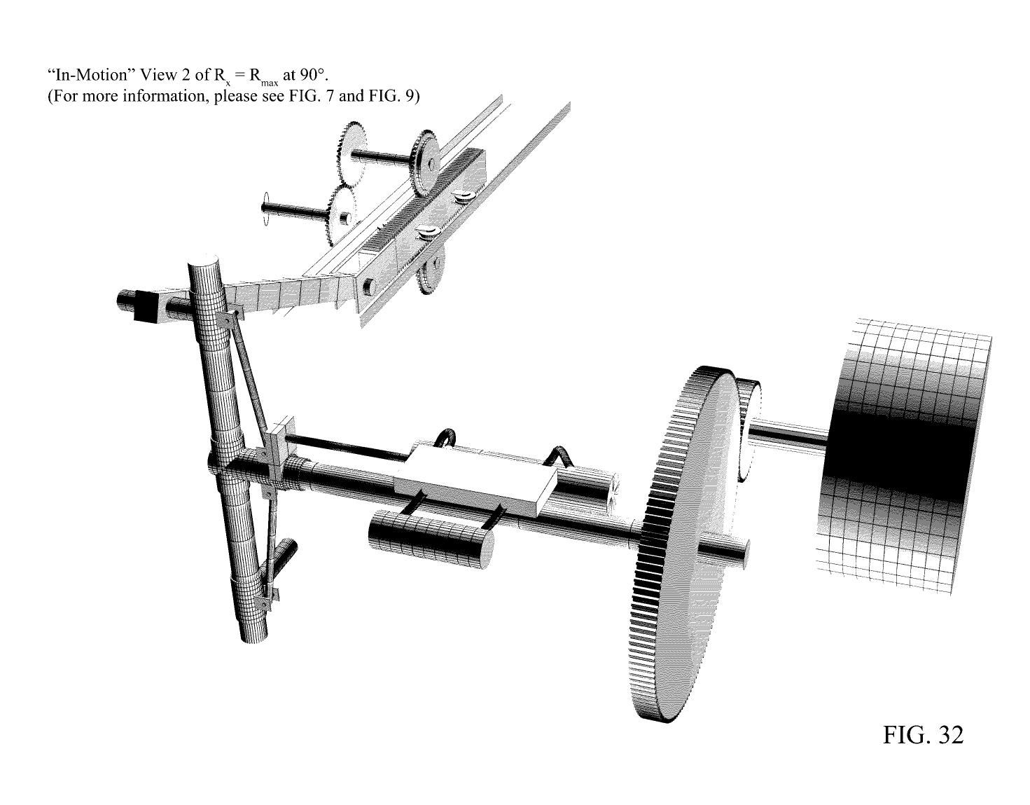

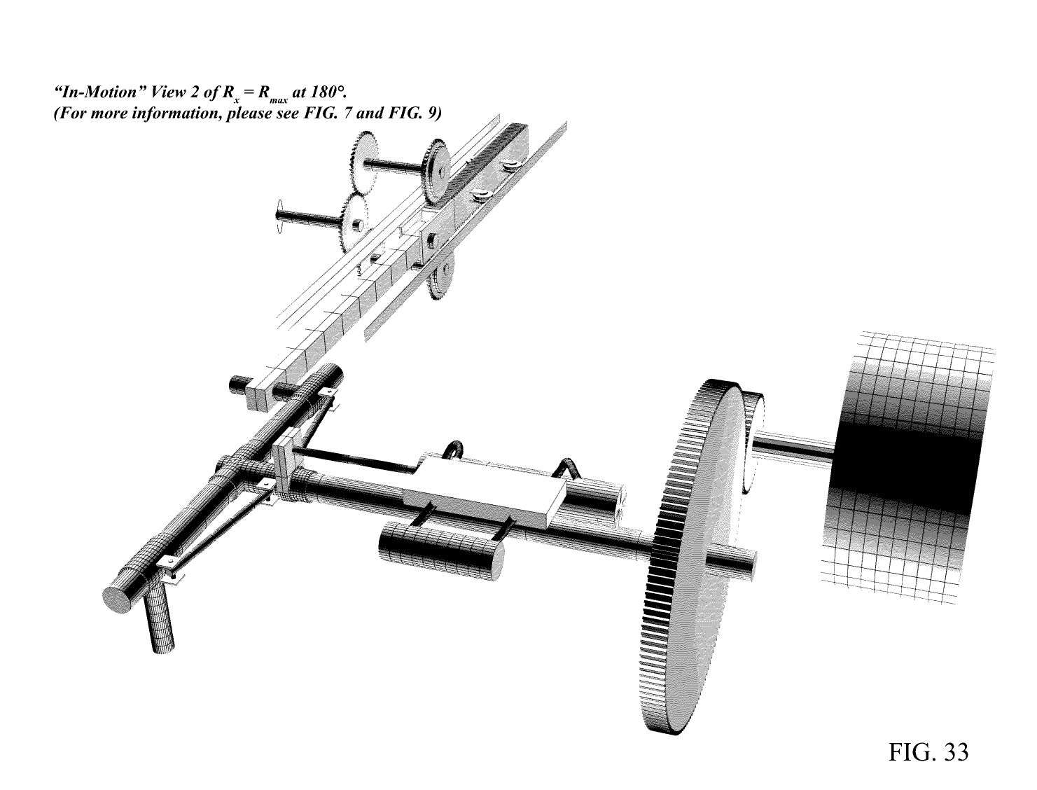

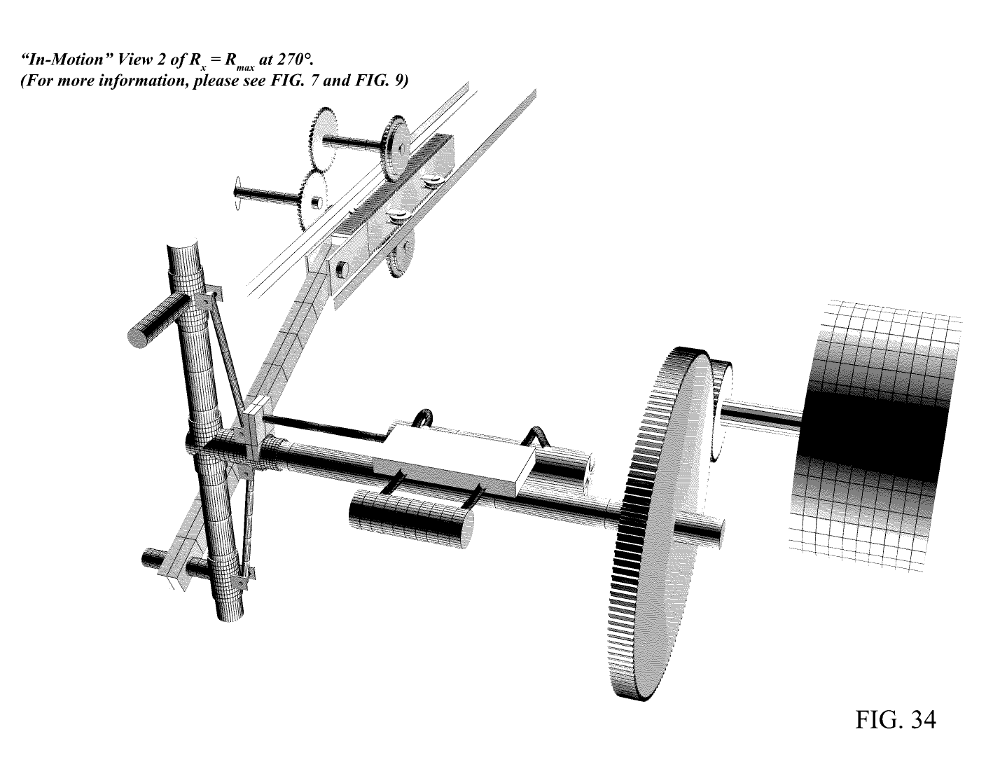

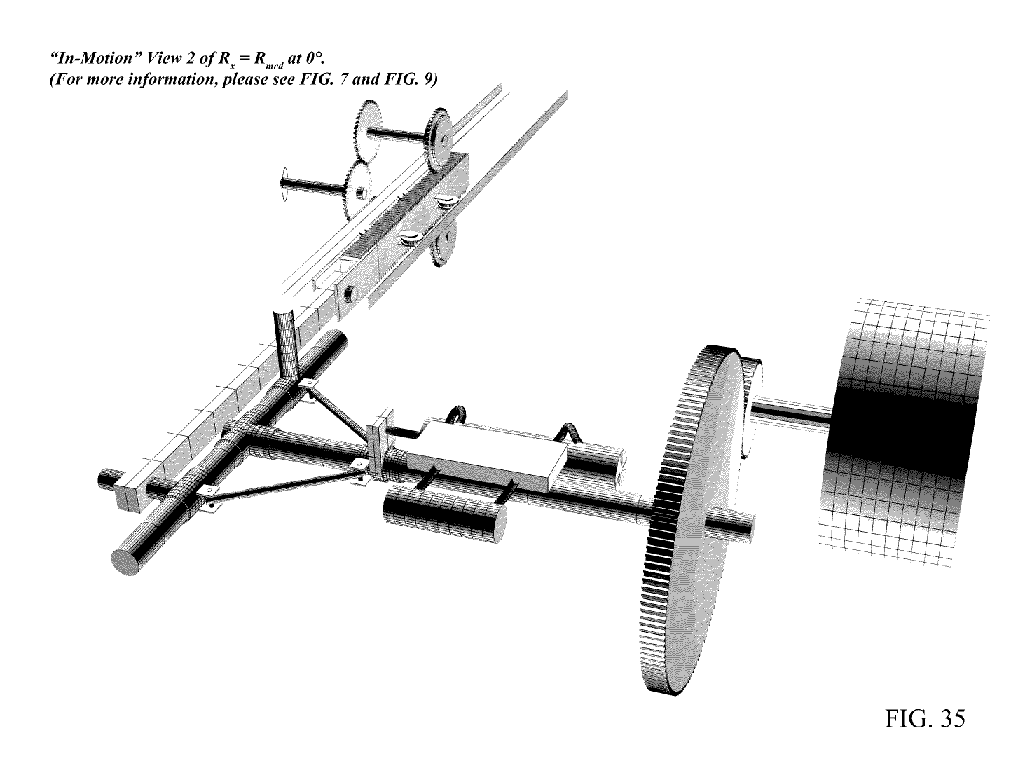

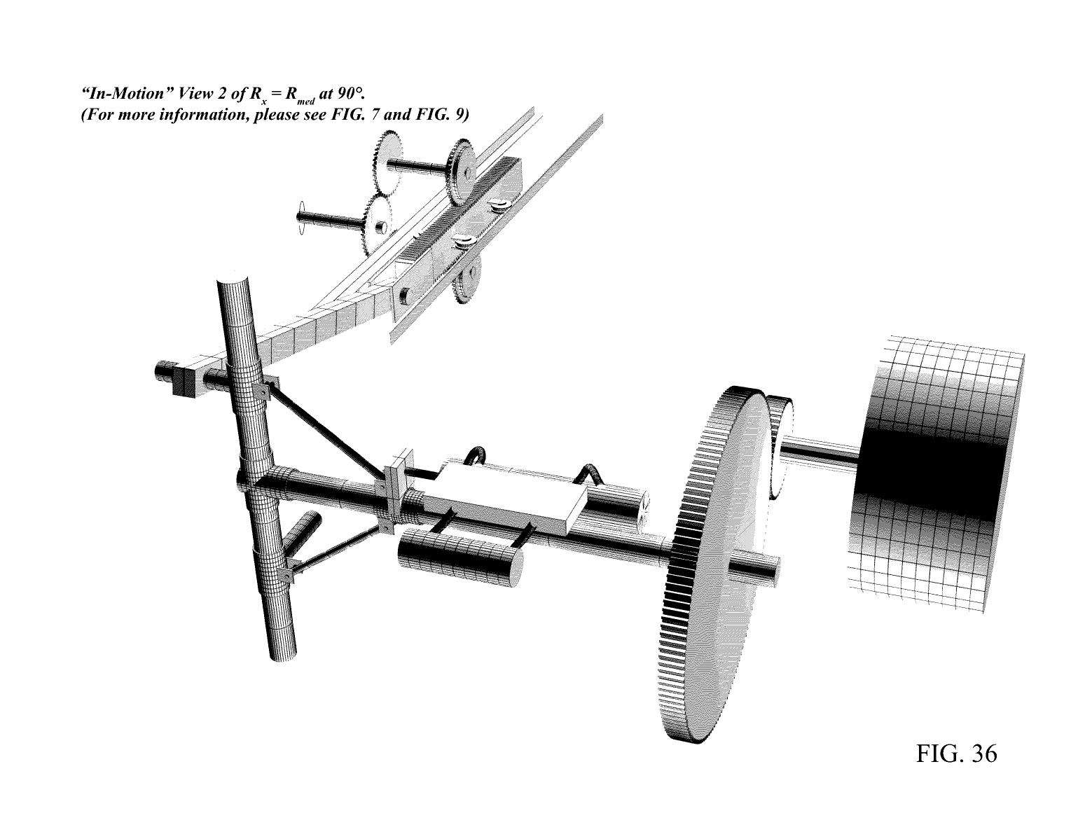

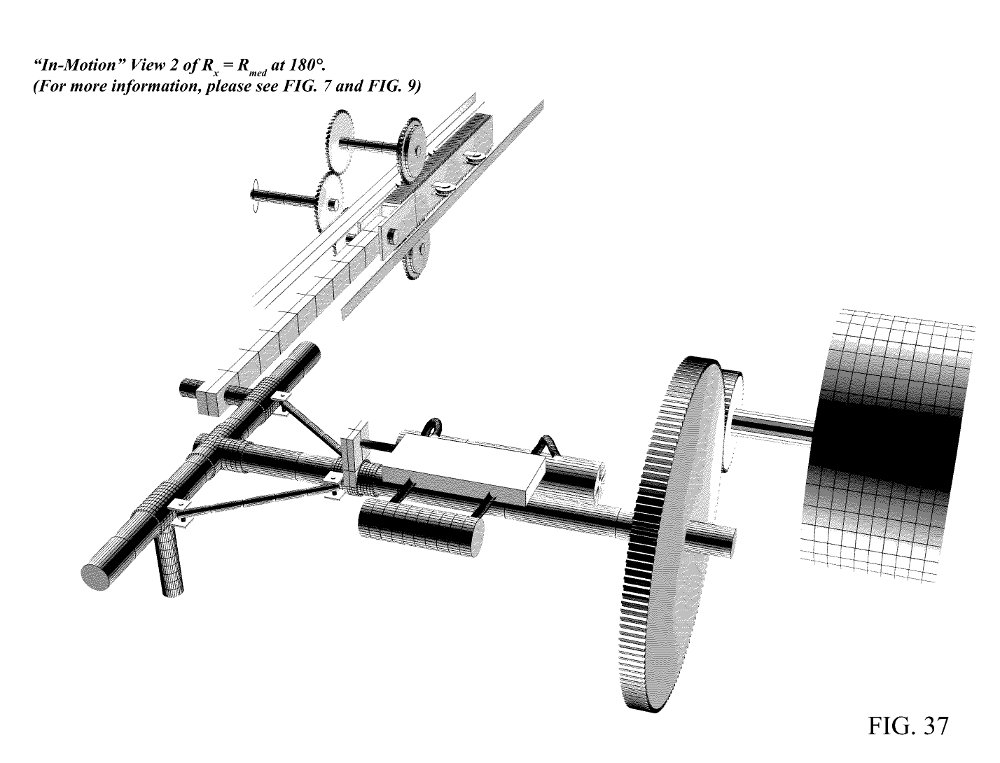

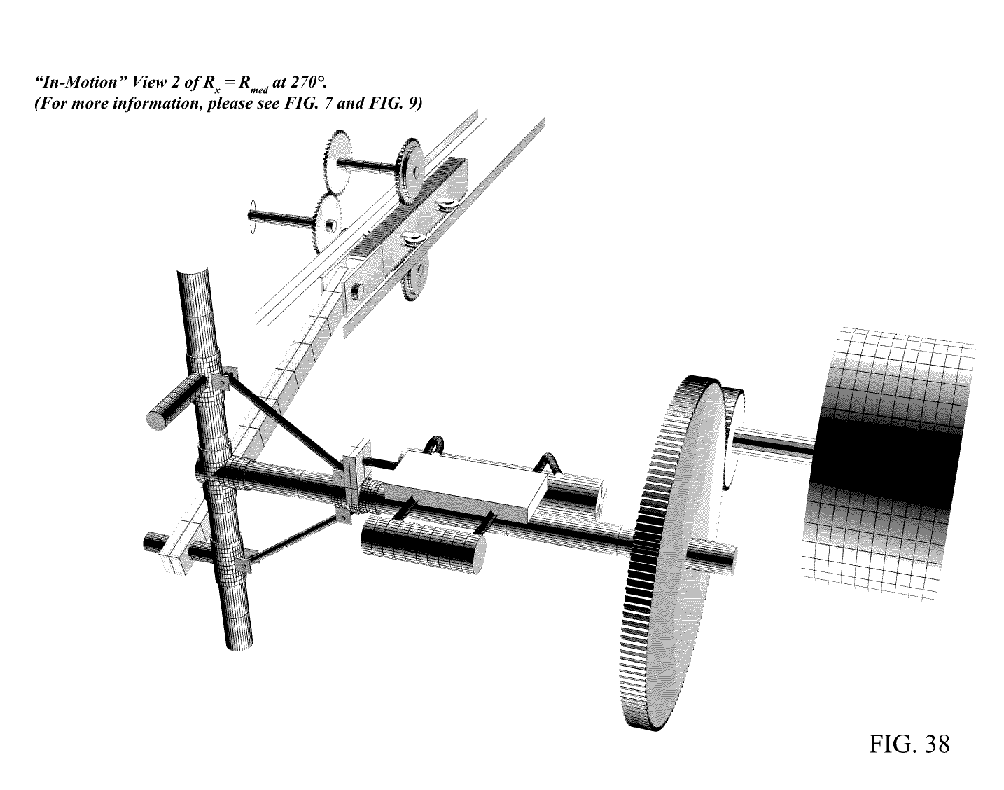

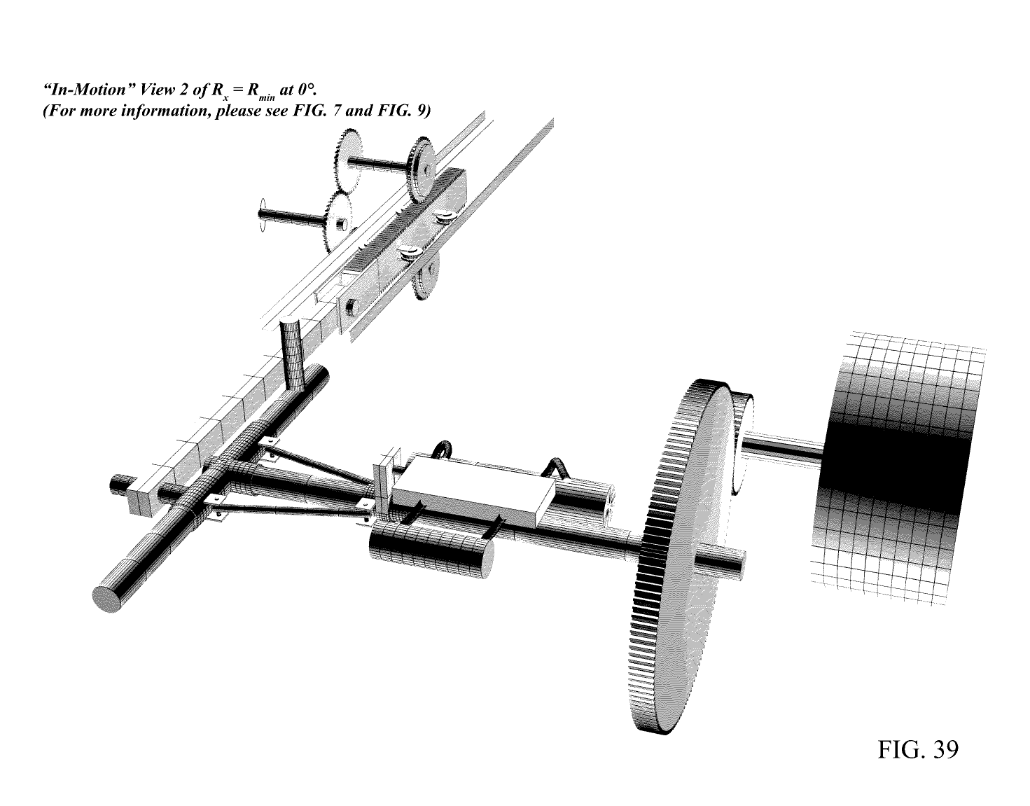

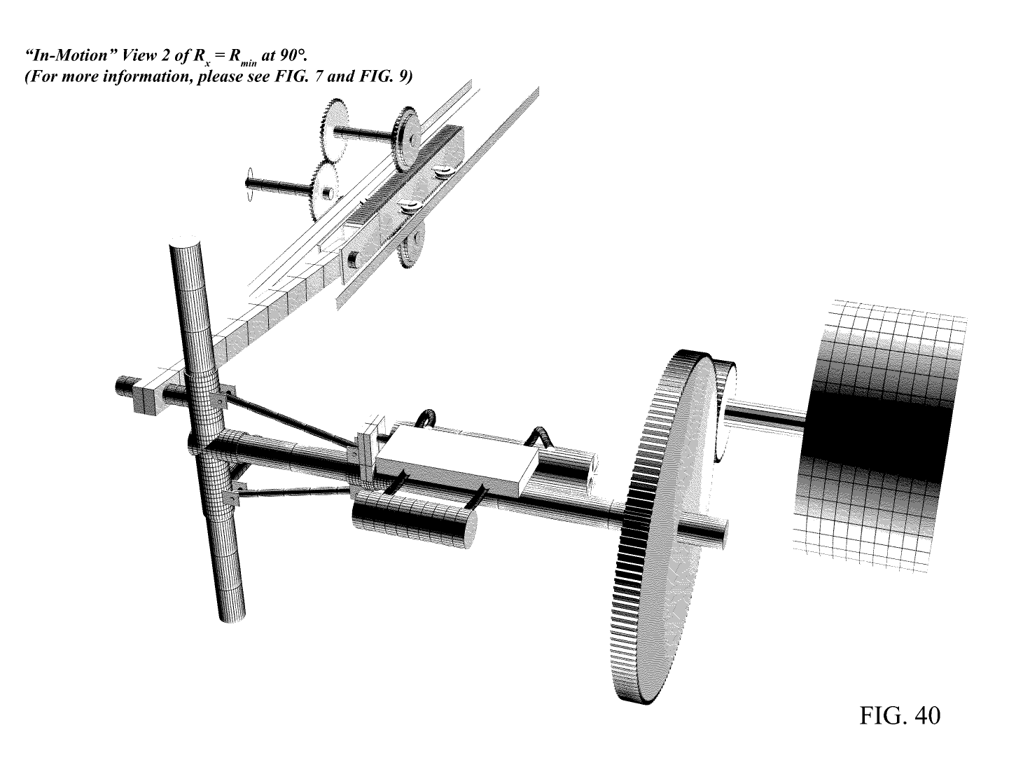

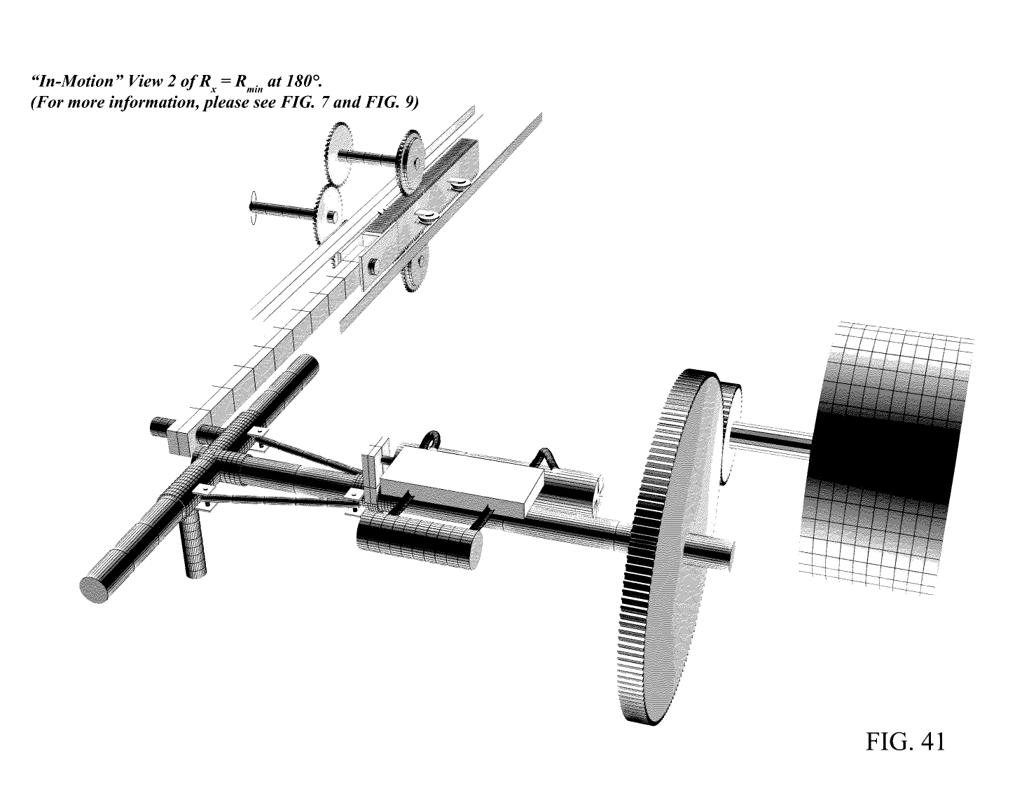

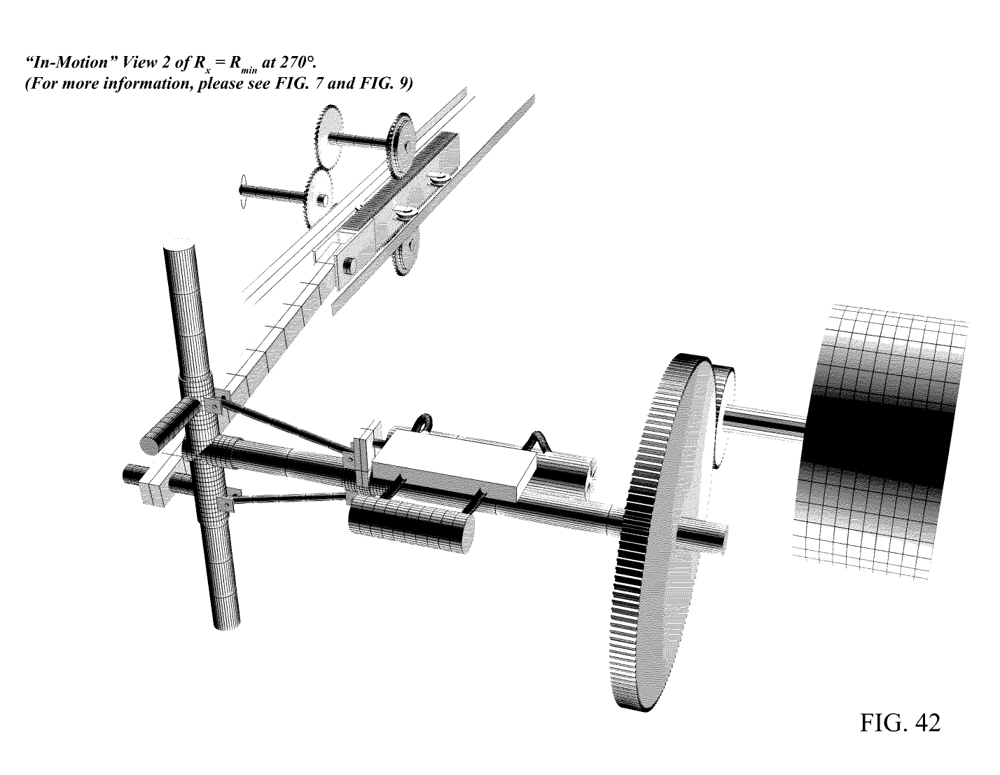

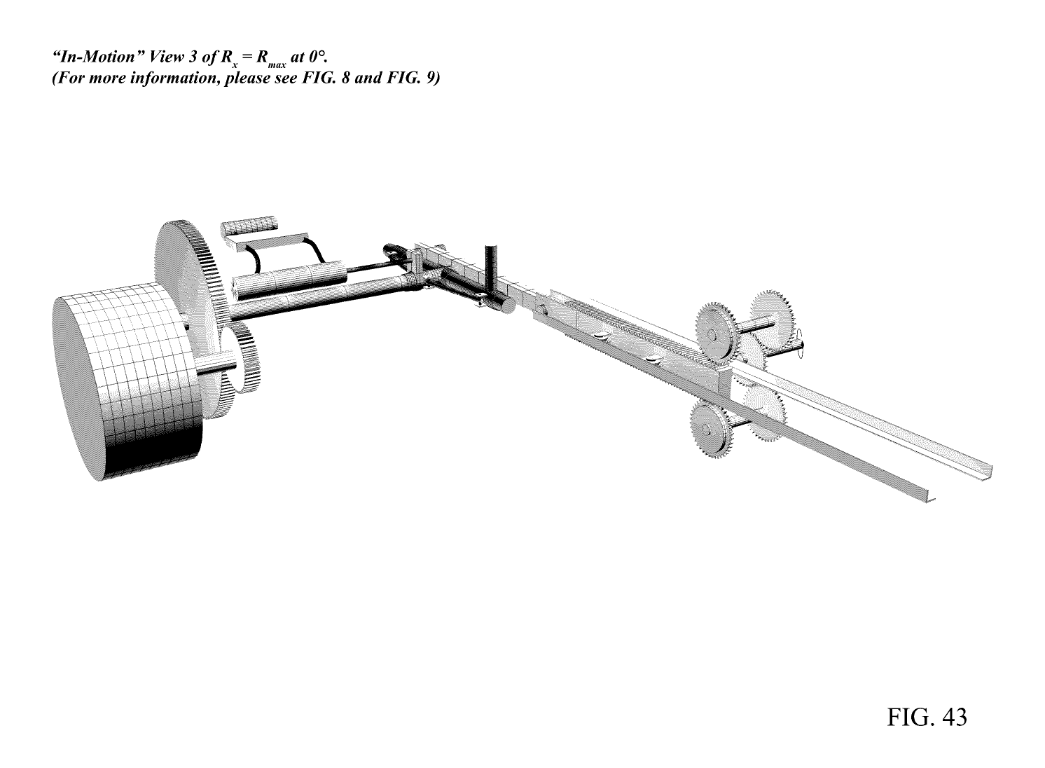

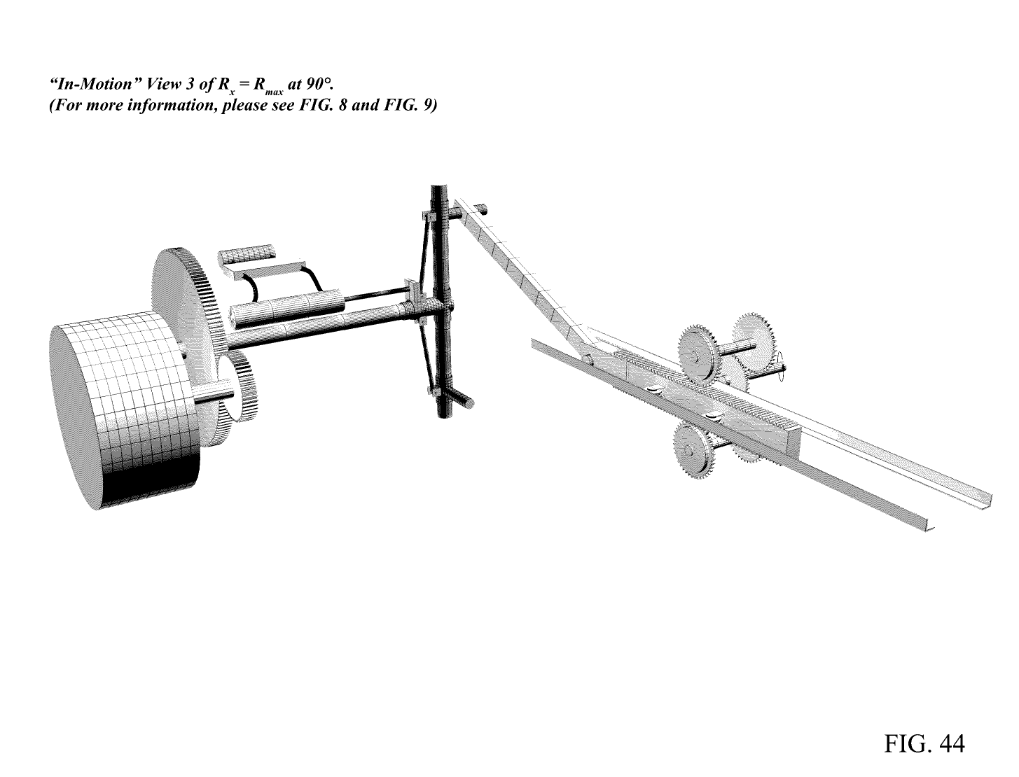

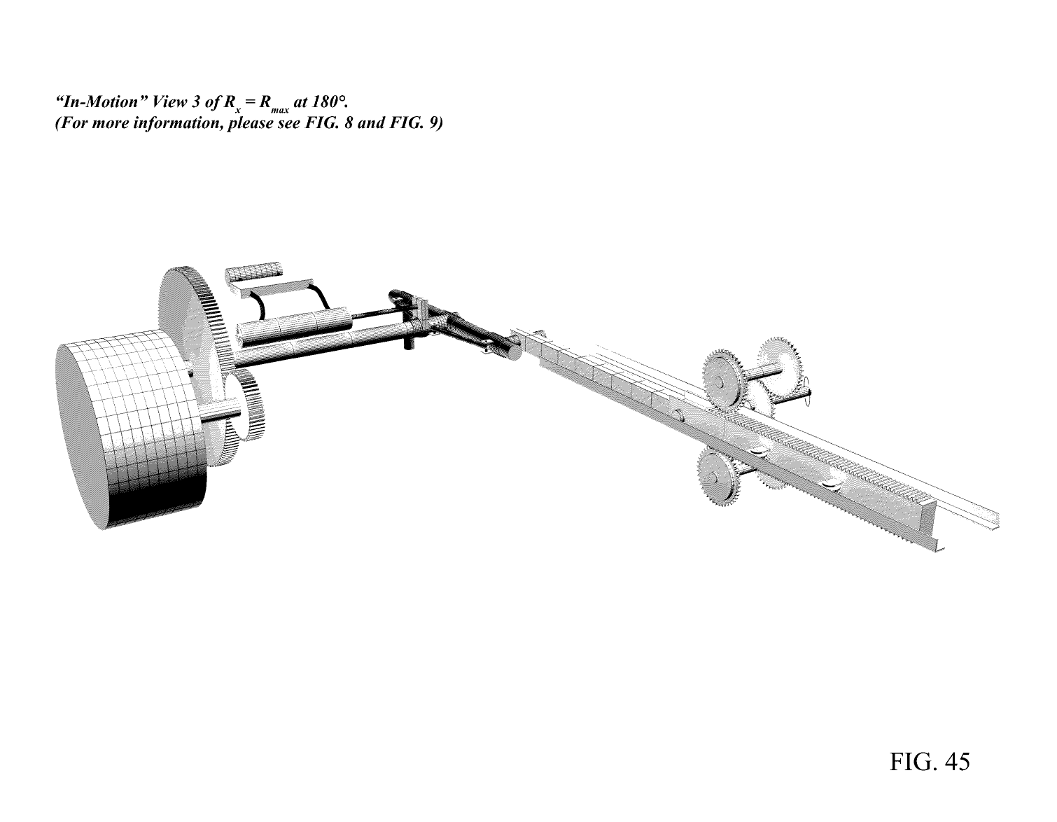

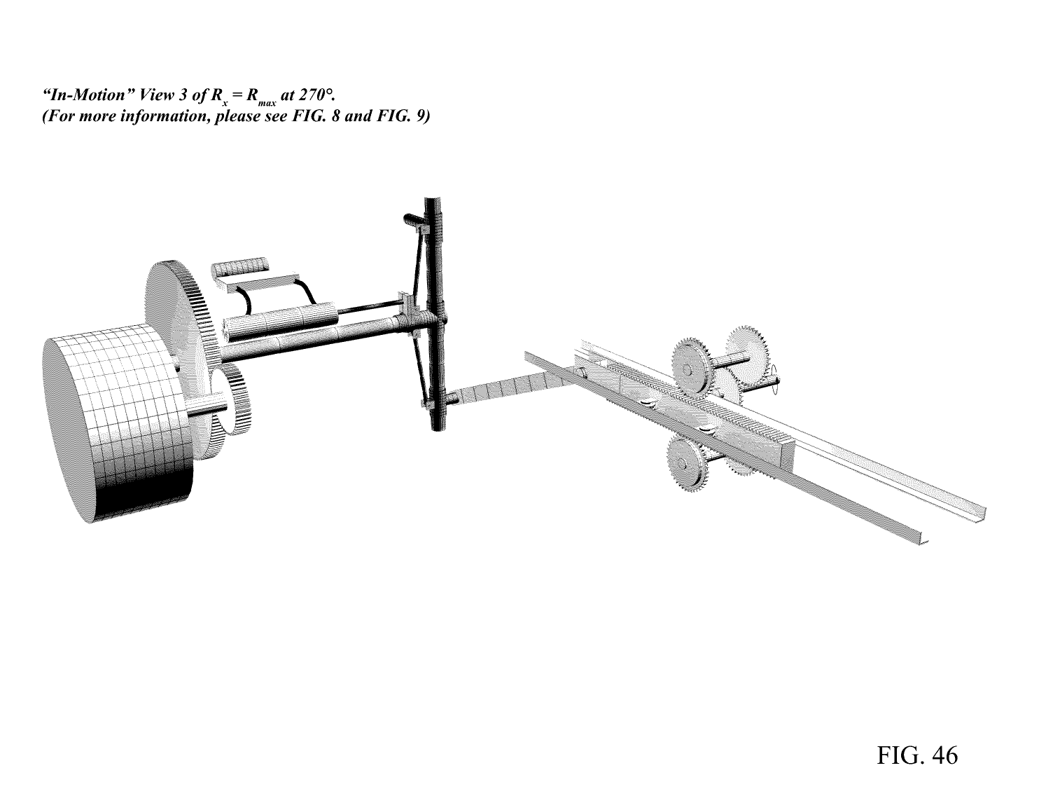

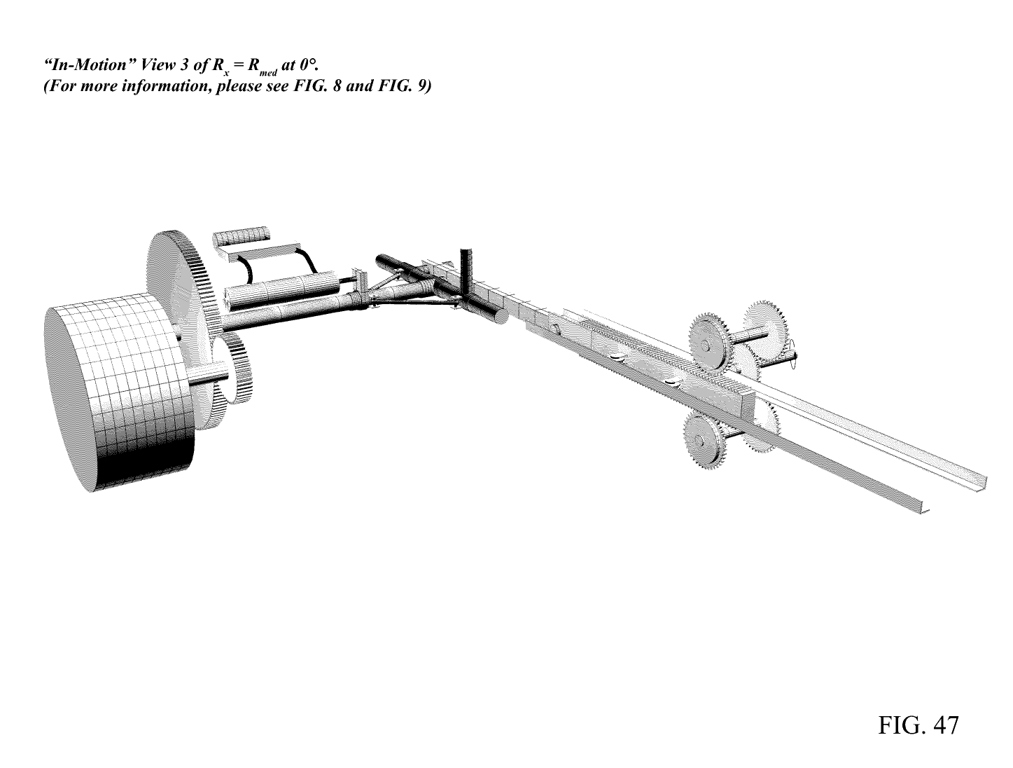

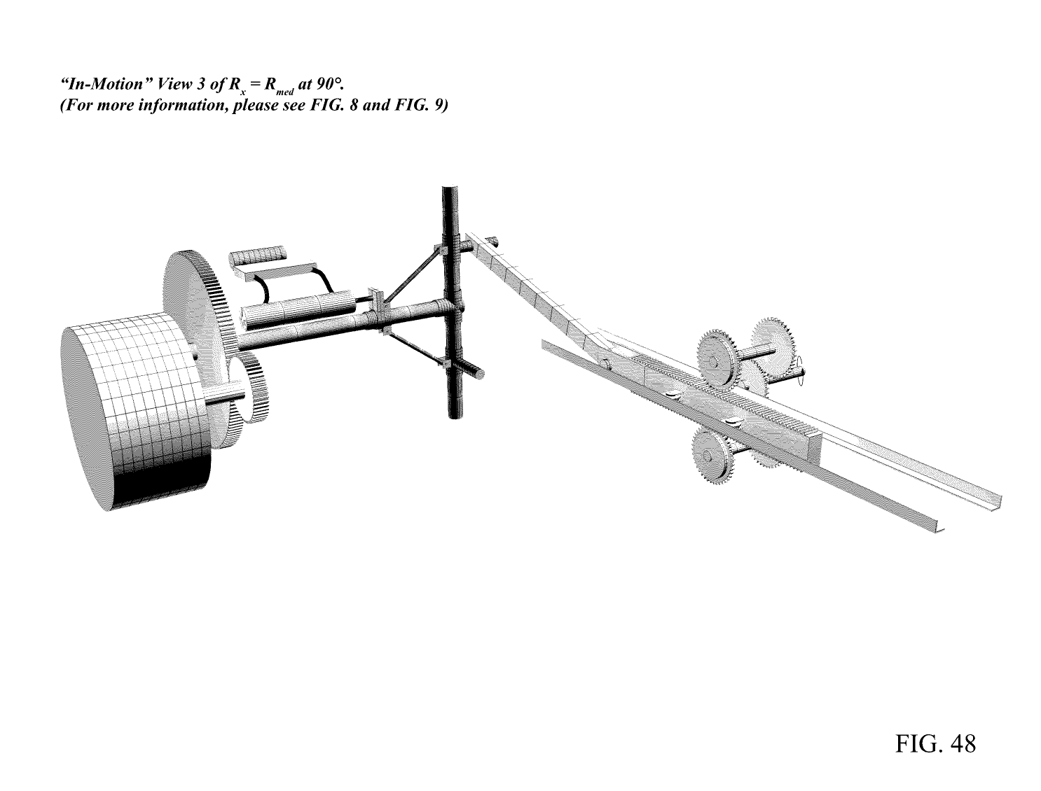

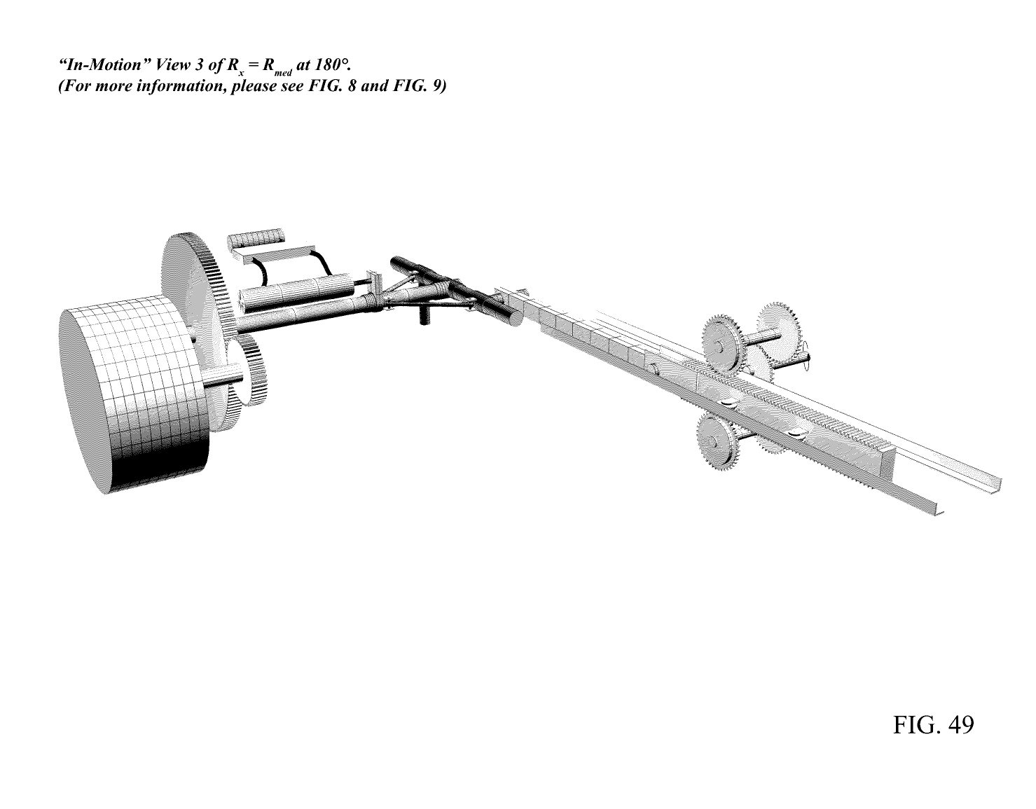

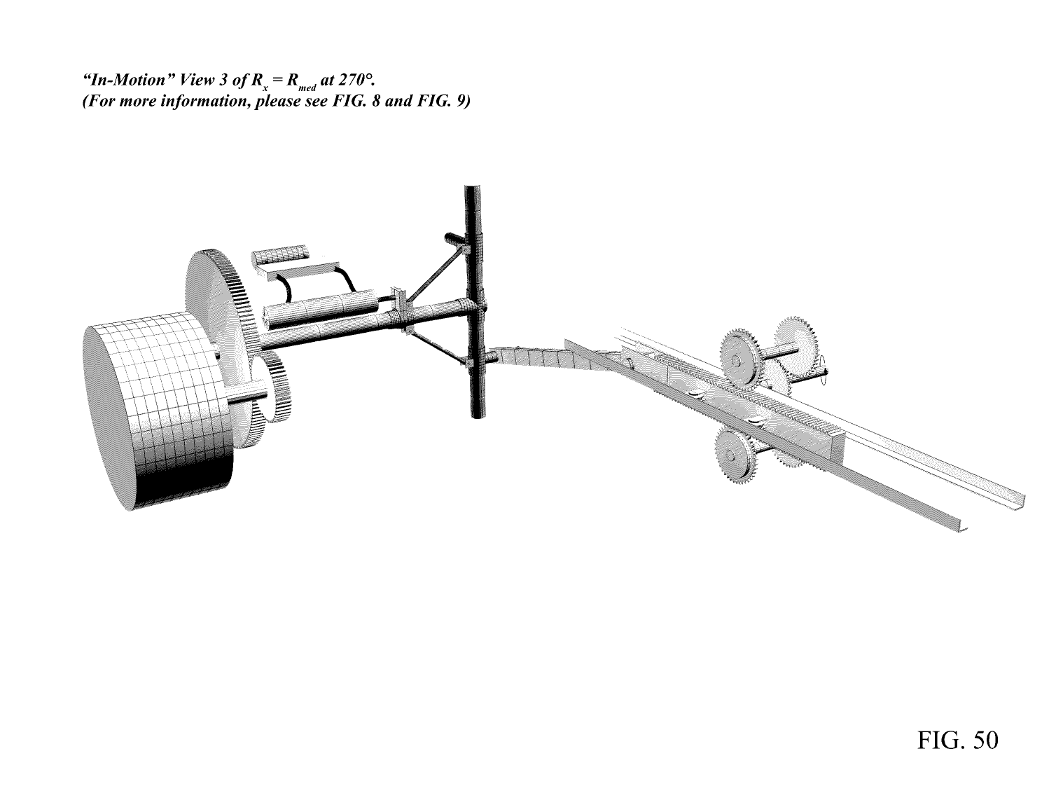

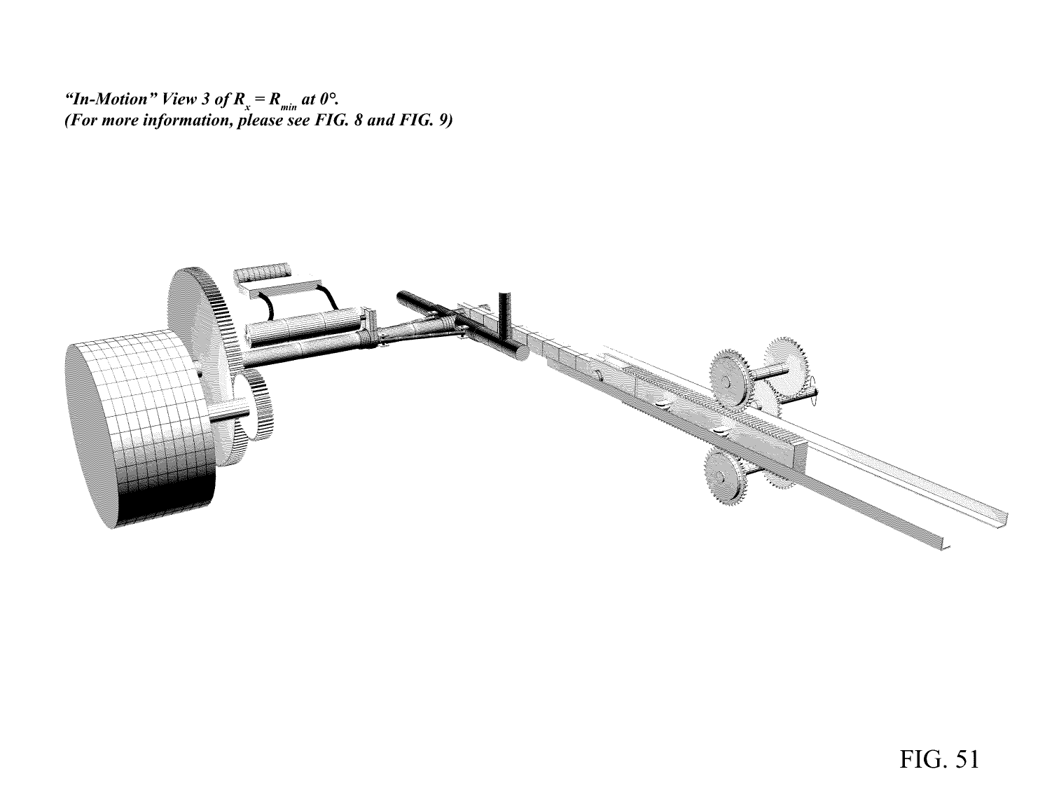

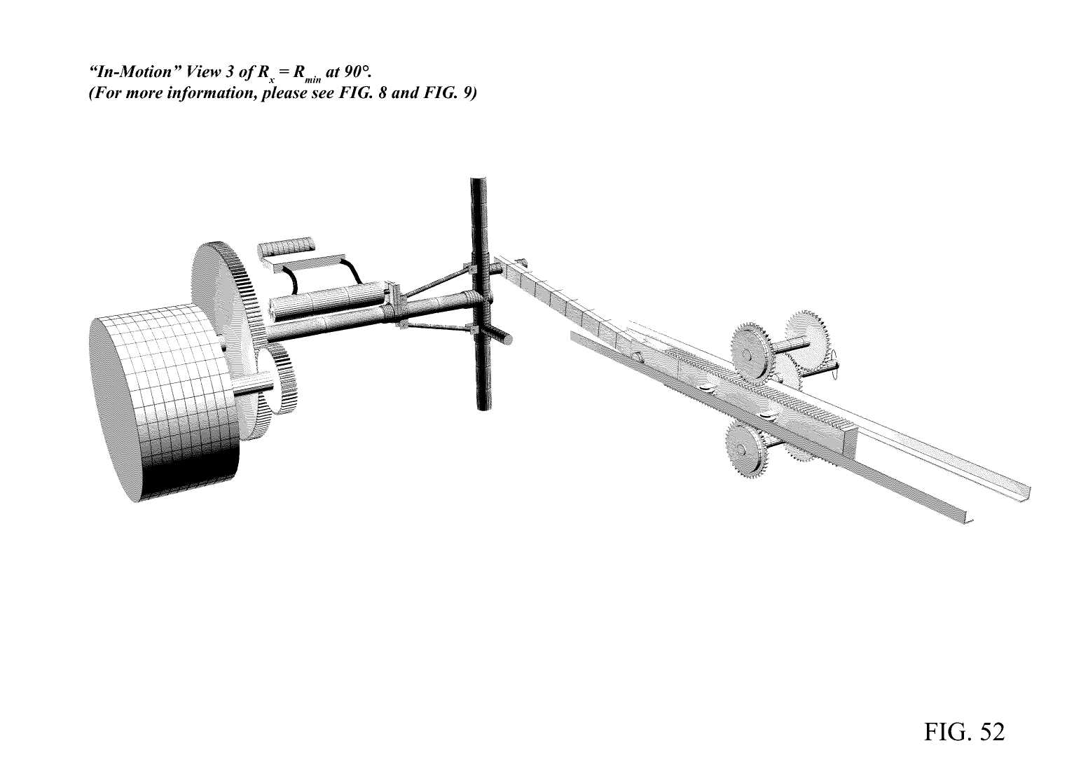

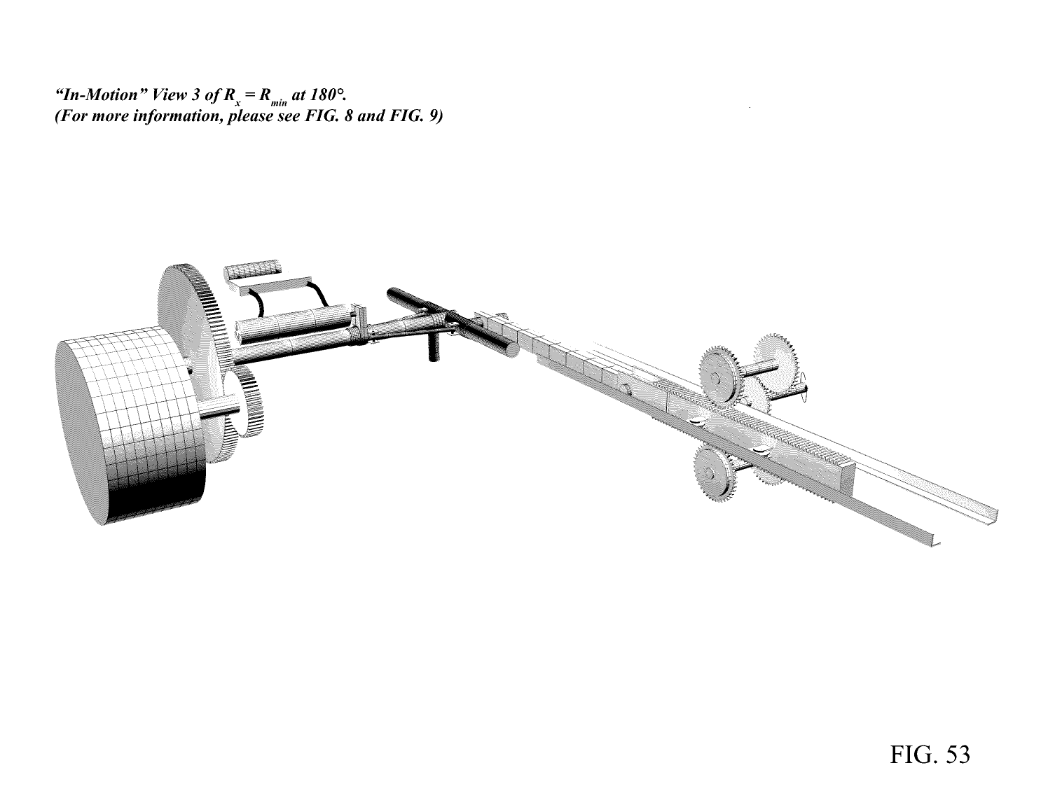

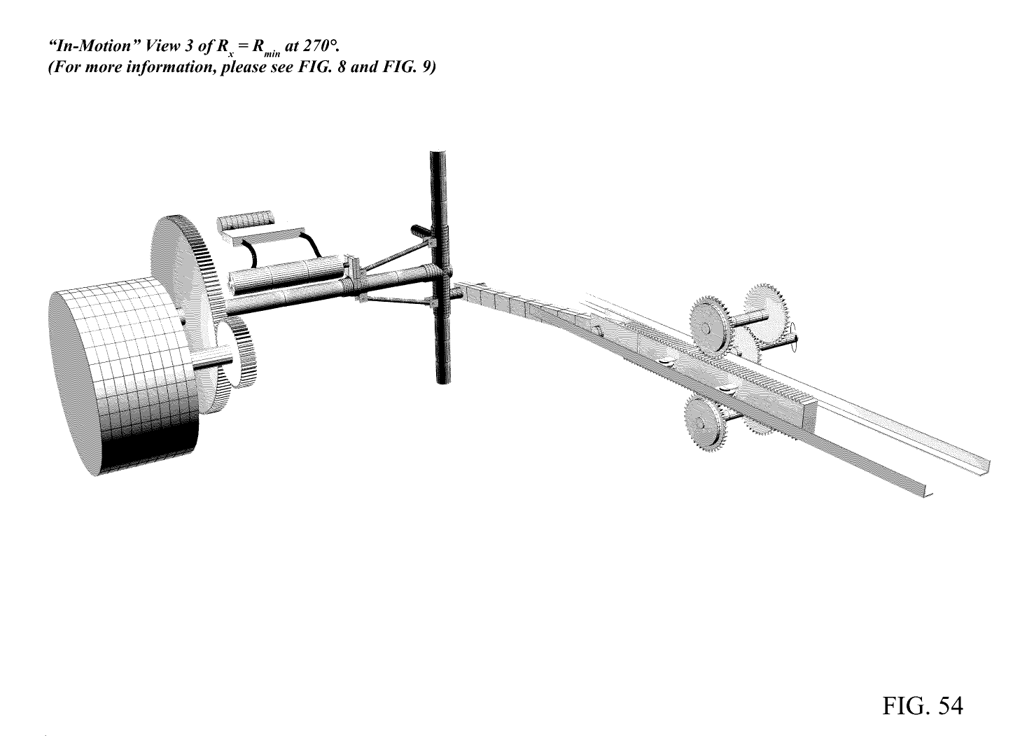

### DRAWINGS *For all drawing clarifications, please refer to “Legend” on pages 5-7.

| Drawing | |
|---|---|
| Number | Function |
| FIG. 1 | 26, 34, 35 & 36 “Exploded” |
| | and “Combined” Axonometric Drawing |
| FIG. 2 | 26, 34, 35 & 36 “Section Cut” and |
| | “Combined” Axonometric Drawing |
| FIG. 3 | Enlarged 3D View of freewheel |
| | and gear system (For detailed view, please |
| | see FIG. 10, FIG. 11, FIG. 12, FIG. 13 |
| | and FIG. 14). |
| FIG. 4 | Enlarged Elevation view of freewheels |
| | (Similar to a rack & pinion system) |
| | (For detailed view, please see FIG. 10, FIG. |
| | 11, FIG. 12., FIG. 13 and FIG. 14) |
| FIG. 5 | Enlarged view of 3, 4, 5 & 6 (For detailed |
| | view, please see FIG. 10, FIG. 11, FIG. 12, |
| | FIG. 13 & FIG. 14) |
| FIG. 6 | View 1 General Perspective |
| FIG. 7 | View 2 General Perspective |
| FIG. 8 | View 3 General Perspective |
| FIG. 9 | R = Rₓ/R₀ View |
| FIG. 10 | Enlarged 3D View of FIG. 3, FIG. 4 |
| | and FIG. 5. |
| FIG. 11 | Enlarged 3D View of FIG. 3, FIG. 4 |
| | and FIG. 5. |
| FIG. 12 | Enlarged 3D View of FIG. 3, FIG. 4 |
| | and FIG. 5. |
| FIG. 13 | Enlarged 3D View of FIG. 3, FIG. 4 |
| | and FIG. 5. |
| FIG. 14 | Enlarged 3D View of FIG. 3, FIG. 4 |
| | and FIG. 5. |
| FIG. 15 | Enlarged 3D View of the Shifting |
| | Mechanism (For more information, please |
| | see FIG. 1 and FIG. 2) |
| FIG. 16 | Enlarged 3D View of the Shifting |
| | Mechanism (For more information, please |
| | see FIG. 1 and FIG. 2) |
| FIG. 17 | Enlarged 3D View of the Shifting |
| | Mechanism |
| FIG. 18 | System Location Diagram |
| FIG. 19-FIG. 30 | View #1 “In-Motion” |
| FIG. 31-FIG. 42 | View #2 “In-Motion” |
| FIG. 43-FIG. 54 | View #3 “In-Motion” |

*Note
regarding FIG. 19-FIG. 30, FIG. 31-FIG. 42 & FIG. 43-FIG. 54:
Rₓ:
a.) Range of ‘X’ from minimum radius to maximum radius.
b.) Min., Med., and Max. are only representational of variables and do not mean that there are only 3 “speeds.”
c.) Example: ‘X’ is ANY VARIABLE between min. <----> max.
General Notes:
1.) Items on all of the drawing sheets are to be mounted on an appropriate housing (not shown in drawings.)
2.) We have already built a model of this power transmission system (Original Shift System (O.S.S.)) and verified that this concept works as described and designed.

### B.) Legend *For items listed in the legend below, please refer to drawings FIG. 1-FIG. 19.

| Number | Item | Notes |
|---|---|---|
| 1 | Freewheel | Similar to the “pinion” in |
| | | rack & pinion |
| 2 | Freewheel | Similar to the “pinion” in |
| | | rack & pinion |
| 3 | Gear | Regular gear |
| 4 | Gear | Regular gear |
| 5 | Output gear | Regular gear |
| 6 | Output shaft | Rotational power output |
| 7 | Shaft | Connecting 1 to 3 |
| 8 | Shaft | Connecting 2 to 4 |
| 9 | Main rod | |
| 10 | Main rod rack | Mounted on top and |
| | | bottom of 9, similar to the |
| | | “rack” in rack & pinion. |
| | | (Please see drawings FIG. 3, |
| | | FIG. 4, FIG. 10, FIG. 11, FIG. |
| | | 12, FIG. 13 & FIG. 14) |
| 11 | Connecting rod | Attached to 13 and 16 |
| 12 | Pivoting hinge mechanism | |
| 13 | Hinge pin | Connecting 9 and 11 |
| 14 | Sliding direction of 9, 10 | |
| 15 | Sliding direction of 9, 10 | |
| 16 | Crankpin | Connected to 20. 20 slides |
| | | on 18. 16 controls Rₓ's size. |
| | | (‘X’ is VARIABLE between |
| | | min. <----> max.) |
| 17 | Rail | 9 and 10 uses 31 to slide on |
| | | 17. 2 total |
| 18 | Rotating arm | |
| 19 | Stretcher | Connects 20 and 26 via 23 |
| | | and 24. 2 total |
| 20 | Sliding sleeve | Slides on 18. One attaches |
| | | to 16 and 24. One attaches |
| | | to 37 and 24. 2 total |
| 21 | Main rotating shaft | Connected to 18 on one |
| | | end and 28 on the other |
| 22 | Hydraulic piston rod | 22 is attached to 25. 22 is |
| | | controlled by 27 |
| 23 | Stretcher attachment pin | 4 total (Please see FIG. 16) |
| 24 | Flanges for stretcher | 4 sets of 2, 8 total |
| | attachment | (Please see FIG. 16) |
| 25 | Rod end | Attaches to 34. Together, |
| | | they push 26 and 36 on 21 |
| | | and pull 35 and 36 on 21 |
| 26 | Front Collar | Attaches to the front end of |
| | | 36. (Please see FIG. 1 and |
| | | FIG. 2) |
| 27 | Hydraulic cylinder | Double acting, uses 22 to |
| | | push and pull 25. |
| | | Controlled by 33 |
| 28 | Reduction gear | Attached to 21, and |
| | | engages with 29 |
| 29 | Input gear | Powered by 40 via 30, and |
| | | engages with 28 |
| 30 | Input shaft | Connects 29 to 40 |
| 31 | Sliding Wheel used by 9 | Allows 9 to slide on 17. |
| | | 4 total |
| 32 | Hydraulic Oil Hose Pipe | Connects 27 to 33 |
| 33 | Hydraulic Control Unit | One side attached to 27, |
| | | one side attached to 39 |
| 34 | Collar | 34 is a non-rotating collar |
| | | on 36 that is sandwiched |
| | | between 26 and 35, but is |
| | | not attached to them. |
| | | Therefore, 34 slide |
| | | reciprocally together with |
| | | 26, 35 and 36 on 21 |
| | | (Please see FIG. 1 and FIG. |
| | | 2) |
| 35 | Back Collar | Attaches to the back end of |
| | | 36. (Please see FIG. 1 and |
| | | FIG. 2) |
| 36 | Sliding Cylinder | 36 is a cylinder that slides |
| | | reciprocally and rotates on |
| | | 21. 36 is able to slide in a |
| | | reciprocal motion because |
| | | of 34, which is connected |
| | | to 25, which in turn is |
| | | powered by 27. (Please see |
| | | FIG. 1 and FIG. 2) |
| 37 | Balancer | Connected to 20, to |
| | | counterbalance 16, total: 1 |
| 38 | Hydraulic Oil Hose Pipe | Connects 39 to 33 |
| 39 | Pump | Provides oil to 33 and 27 |
| 40 | Power Source (motor or | Provides power through 30 |
| | engine) | to Original Shift System |
| | | (O.S.S.) |

### C.) Operation

Note:
1.) Further explanation below used to explain the key components in the operation of the Original Shift System (O.S.S.).
2.) For a visual example of the Original Shift System (O.S.S.) “in motion,” please refer to drawings FIG. 19-FIG. 30, FIG. 31-FIG. 42 & FIG. 43-FIG. 54. Radius and angle for each drawing is specified on each drawing.
   Freewheel (System 2 on FIG. 18) *Please refer to drawings FIG. 3, FIG. 4, FIG. 5, FIG. 10, FIG. 11, FIG. 12, FIG. 13, & FIG. 14 for views.

A.) When 9, along with 10 slides in the direction of 15, 10 engages with 1 and 2 in a rack & pinion fashion. 2 rotates in an “engaged” clock-wise direction and then also rotates 4 through their common shaft 8. In this situation, 4 (rotating clock-wise) engages 5 to rotate in a counter clock-wise direction, which in turn engages 3 to rotate in a clock-wise direction. When this occurs, 3 (rotating clock-wise) is rotating independently of 1 (rotating in a counter clock-wise direction), and thus 1 is in disengaged “idling.”

B.) When 9, along with 10 slides in the direction of 14, 10 engages with 1 and 2 in a rack & pinion fashion. 1 rotates in an “engaged” clock-wise direction and then also rotates 3 through their common shaft 7. In this situation, 3 (rotating clockwise) engages 5 to rotate in a counter clock-wise direction, which in turn engages 4 to rotate in a clock-wise direction. When this occurs, 4 (rotating clock-wise) is rotating independently of 2 (rotating in a counter clock-wise direction), and thus 2 is in disengaged “idling.”

C.) Regardless of what direction 9 and 10 are traveling in (to 14 or 15), 3 and 4 will always rotate in a clock-wise direction and 5 will always rotate in a counter clock-wise direction.

D.) Power can thus be transferred out by 5 through 6. The output format is rotational and is always counter clock-wise.

### How to “Shift” (System 1 on FIG. 18)

*Please refer to drawings FIG. 1, FIG. 2, FIG. 6, FIG. 7, FIG. 8, FIG. 9, FIG. 15, FIG. 16 & FIG. 17 for views.

A.) 19 is composed of two rods that act as stretchers (similar to stretchers in opening and closing an umbrella.)

B.) Each 19 is attached in two locations:
a. Location #1 (Please see FIG. 15): 19 is attached to 26 via 23 and 24.
b. Location #2 (Please see FIG. 17): 19 is attached to 20 via 23 and 24.

C.) When 27 extends 22 and pushes 25, 34, 26 and 36; Location #1 slides out with 26 to the tip of 21 (towards 18). At the same time, Location #2 slides out with 20 to the tip of 18. As a result, the radius that is created by 16 is enlarged. (This action is similar to an “up-shift” in a car (towards a higher speed with lower torque.))

D.) When 27 retracts 22 and pulls 25, 34, 35 and 36; Location #1 slides in with 35 to the base of 21 (away from 18). At the same time, Location #2 slides in with 20 to the center of 18. As a result, the radius that is created by 16 is reduced. (This action is similar to a “down-shift” in a car (towards a lower speed with higher torque.))

E.) This extending (C from above) and retracting (D from above) motion creates the variable in Rₓ through 16. (Please refer to drawing FIG. 9)

F.) 16 rotate together with 18. 16 is connected to 11, and 11 is connected to 9 which moves in a reciprocal motion along 17. This linkage process serves as a crankshaft mechanism, successfully transferring rotational power from 18 into the reciprocal motion in 9. (Please refer to drawings FIG. 19-FIG. 30, FIG. 31-FIG. 42 & FIG. 43-FIG. 54)

G.)

R=Rₓ/R₀

Where:
R is a ratio.
Rₓ:
   a.) Range of ‘X’ from minimum radius to maximum radius.
   b.) Min., Med., and Max. are only representational of variables and do not mean that there are only 3 “speeds.”
   c.) Example:

‘X’ is any variable between min. <—>max.
R₀:
   a.) Radii of 1 & 2. R₀ is a constant.
   *Please refer to “Legend” on pages 5-7 (for clarification of 1 & 2) and drawing FIG. 9.

### D.) SUMMARY

### CVT Disadvantages:

A.) Due to the physical limitations of a CVT in using the “cone” concept or a belt/chain driven system, the resulting transmission is suitable only for low torque scenarios (such as small passenger vehicles and light duty machinery.)

B.) The cones or belt/chains of a CVT must be kept tight in order to supply enough friction to be able to successfully transfer power and to prevent “slipping.” This energy that is used to keep the cones and belt/chains tight is effectively another form of wasting energy and thus reducing overall efficiency.

C.) “Lag” time from when the gas pedal is depressed to when the car accelerates. This is due to the physical limitations of the CVT system of cone or belt/chains. This results in slower acceleration and a lack of torque.

D.) Increased overall NVH (noise, vibration and harshness), which decreases the overall experience for the passenger.

E.) Decreased reliability and service life.

### Original Shift System (O.S.S.) Benefits:

A.) Original Shift System (O.S.S.) employs only gears and hydraulics for the transmission of power, therefore the system and concept is completely different than that of CVTs. It has the ability to be used in any torque scenario, from low-torque to heavy duty scenarios (such as large passenger automobiles, large trucks and heavy duty machinery.)

B.) Original Shift Systems (O.S.S.) uses only gears and hydraulics for the transmission of power. Due to this physical difference, there is no need to use additional energy to keep the mechanism “tight enough” in order to “engage” and to prevent any “slipping.” Therefore, unlike a CVT, there is no energy loss from keeping the mechanism “tight enough” and as a result there is increased overall system efficiency.

C.) Original Shift Systems (O.S.S.) uses only gears and hydraulics for the transmission of power. Therefore, the transmission of power is “instant” and does not suffer from the “lag” in acceleration associated with CVTs. This results in better acceleration and therefore greater control, efficiency and safety.

D.) Original Shift Systems (O.S.S.) uses only gears and hydraulics for the transmission of power. Due to this major difference from CVTs, Original Shift System (O.S.S.) does not suffer from typical NVH (noise, vibration and harshness) issues associated with acceleration. As a result, the Original Shift System (O.S.S.) will also have lower NVH during operation than a CVT.

E.) Original Shift System (O.S.S.) is drastically simpler in structure than a CVT. As a result of this simplification, Original Shift System (O.S.S.) is therefore more reliable and has a longer service life. Manufacturing will not only be faster but also more affordable. Therefore, the Original Shift System (O.S.S.) will be more accessible to the market and thus gain a wider market reach.

F.) Original Shift System (O.S.S.) is always set in the most suitable and efficient gear ratio, regardless of speed or condition. As a result, it has drastically reduced energy consumption and therefore is more environmentally friendly.

G.) Original Shift System (O.S.S.) is particularly suitable for situations of high stress (such as auto racing, or climbing mountainous terrain.) This is due to the Original Shift System (O.S.S.)'s ability for instantaneous acceleration, thus allowing for greater control and safety.

### List of Corrections made on Drawings

| Drawing | What changes were made |
|---|---|
| FIG. 1 | 1. Changed A1 to FIG. 1. |
| | 2. Changed line weights to increase visibility. |
| | 3. Changed size of drawing to increase visibility. |
| FIG. 2 | 1. Changed A2 to FIG. 2. |
| | 2. Changed line weights to increase visibility. |
| | 3. Changed size of drawing to increase visibility. |
| FIG. 3 | 1. Changed A3 to FIG. 3. |
| | 2. Changed line weights to increase visibility. |
| | 3. Addition of small description on top left corner. |
| FIG. 4 | 1. Changed A4 to FIG. 4. |
| | 2. Changed line weights to increase visibility. |
| | 3. Addition of small description on top left corner. |
| FIG. 5 | 1. Changed A5 to FIG. 5. |
| | 2. Changed line weights to increase visibility. |
| | 3. Addition of small description on top left corner. |
| FIG. 6 | 1. Changed A6 to FIG. 6. |
| | 2. Changed line weights to increase visibility. |
| FIG. 7 | 1. Changed A7 to FIG. 7. |
| | 2. Changed line weights to increase visibility. |
| FIG. 8 | 1. Changed A8 to FIG. 8. |
| | 2. Changed line weights to increase visibility. |
| FIG. 9 | 1. Changed A9 to FIG. 9. |
| | 2. Changed line weights to increase visibility. |
| FIG. 10 | New Sheet. |
| FIG. 11 | New Sheet. |
| FIG. 12 | New Sheet. |
| FIG. 13 | New Sheet. |
| FIG. 14 | New Sheet. |
| FIG. 15 | New Sheet. |
| FIG. 16 | New Sheet. |
| FIG. 17 | New Sheet. |
| FIG. 18 | New Sheet. |
| FIG. 19-FIG. 30 | 1. Changed naming to include “FIG.” |
| | 2. Changed line weights to increase visibility. |
| | 3. Addition of small description on top left corner. |
| | 4. Sheet tagged as “Annotated Sheet.” |
| FIG. 31-FIG. 42 | 1. Changed naming to include “FIG.” |
| | 2. Changed line weights to increase visibility. |
| | 3. Addition of small description on top left corner. |
| | 4. Sheet tagged as “Annotated Sheet.” |
| FIG. 43-FIG. 54 | 1. Changed naming to include “FIG.” |
| | 2. Changed line weights to increase visibility. |
| | 3. Addition of small description on top left corner. |
| | 4. Sheet tagged as “Annotated Sheet.” |

1. The idea of a “step-less” transmission system has a long history spanning several centuries. As early as the late 1400′s, Leonardo Da Vinci first came up with what would be the modern idea of a “step-less” transmission.
However, it wasn't until 1886, when Karl Benz filed the first patent for a friction based belt CVT for automobiles. In the more than 100 years from 1886 to the release of the world's first mass produced automobile with CVT in 1987, to modern day 2015; CVTs have yet to truly attain mass market appeal as the transmission of choice. CVT's rate of progress pales in comparison to the rate and speed of the progress of automobiles. Even modern day CVTs are still plagued by various issues that hinder its progress and appeal.
Continuously variable transmissions (CVT) are “step-less” transmissions that provide an infinite amount of gear ratios for the engine to utilize and allows for greater efficiency in various usage scenarios. However, their biggest flaws are their lethargic and loud acceleration, and their inability to be used in heavy torque scenarios (such as large passenger automobiles, large trucks and heavy duty machinery.)
In comparison, the more popular but traditional “geared” transmissions provide instant acceleration, and are able to be utilized in heavy torque scenarios (such as large passenger automobiles, large trucks and heavy duty machinery.) However, this transmission is not “stepless” and therefore forces the engine to adapt itself to only a few pre-selected gears or “speeds,” effectively preventing the engine from reaching its maximum efficiency and performance.
Original Shift System (O.S.S.) has all of the advantages of CVT and traditional “geared” transmissions with none of their disadvantages. Original Shift System (O.S.S.):)
1. Has instant and quiet acceleration.)
2. Has the ability to be used in any torque scenarios, from low-torque to heavy duty scenario (such as large passenger automobiles, large trucks and heavy duty machinery.))
3. Is a “step-less” transmission system, therefore allowing the engine the ability to reach its maximum efficiency and performance.
We believe that the Original Shift System (O.S.S.) is the solution to the problems that both CVTs and traditional “geared” transmissions face. It will surely attain mass market appeal. We believe that future power transmission systems will be “step-less” and our Original Shift System (O.S.S.) will be at the center to lead this revolution.
Sources:)
1. Sae.org
2.) Howstuffworks.corn
3.) Popularmechanics.com
4.) Gizmag.com
5.) Wikipedia.org
